(19) United States
(12) Patent Application Publication
(10) Pub. No.: US 2026/0350665 A1
(43) Pub. Date: Nov. 5, 2026

(54) INTELLIGENT INFORMATION MANAGEMENT

(71) Applicant: Michael Bilotta, Portola Hills, CA (US)

(72) Inventor: Michael Bilotta, Portola Hills, CA (US)

(21) Appl. No.: 19/656,774

(22) Filed: Apr. 23, 2026

Related U.S. Application Data
(60) Provisional application No. 63/799,112, filed on May 2, 2025.

(51) Int. Cl. G06Q 30/0601; G06Q 10/107; G06Q 30/0241; H04L 9/40

(52) U.S. Cl. CPC G06Q 30/0609; G06Q 30/0277; G06Q 10/107; H04L 63/029

(57) ABSTRACT

An example electronic apparatus for facilitating a sale of a product or service can include: non-volatile memory, one or more processors, and bi-directional communications circuits linked to a network, the network in further communication through a firewall with a partner computing system and one or more data repositories, wherein the one or more data repositories store data relevant to a user, the data relevant to the user comprising one or more data strings corresponding to at least one of demographic, ethnic, social, or psychological information; the one or more data strings further relaying an indication of interaction with the user, wherein the indication of interaction is transmitted through the network to the one or more data repositories and the partner computing system; and the partner computing system comprising displays with representations that the indication of interaction has occurred.

### RELATED APPLICATIONS

This patent application is related to U.S. Patent Application No. 63/799,112 filed on May 2, 2025, the entirety of which is hereby incorporated by reference.

### FIELD OF THE INVENTION

Embodiments of the present invention generally relate to the field of intelligent user and entity data organization, sharing, and refinement by the use of and in some embodiments, specifically relate to an intelligent information management and delivery system, which may use various forms of artificial intelligence to increase accuracy and predictive behavior.

### BACKGROUND

As the Internet and Artificial Intelligence continue to evolve into a more accurate, efficient, and effective network of information, there remains a significant gap between what the users want and what or how the information is exchanged among users, other users, entities, or organizations. Information is used by various interactions, feedback, informational exchanges, portals, customized views, application or device depictions, systemic interactions, statistical derivations, or augmentation. Due to a limited data set, inaccurate inferences, or flaws in current modes of artificial intelligence models, current modes of informational interaction have many limitations that embodiments of the present invention address. Following are some of the factors regarding the limitations of the current techniques: (a) Users or Partners may not accurately understand when they should submit a query or that their situation requires a query; (b) It is almost impossible to use accurate query parameters or terms, keywords, application settings, or algorithms in a way that will yield exactly what the Users or Partners need or want; (c) Even if accurate, timely, and appropriate information is delivered, changes in the User's or Partner's Life State or the information environment may cause what is considered accurate during one time period to become inaccurate during another time period; (d) Because of a User's or Partner's privacy rights, the information delivered will always be inadequate by failing to accurately take into consideration factors hidden or limited by the privacy rights; (e) Because of privacy rights, the information provided may be invasive to a User's or Partner's privacy rights, as the current method of managing privacy rights is flawed; f) There are no User or Partner feedback mechanisms or validations to advise the Partners or Users of the information accuracy, allowing the Partners and Users to more effectively tailor their results for each other; (g) Since the number of organizations and indexed information is theoretically extremely large, there are insufficient mechanisms that causes customized and filtered information to use a method of continuous improvement and focus to yield more relevant query results. Instead, there is the appearance of some relevant information that has varying degrees of accuracy; (h) There are insufficient methods or instruments of accurate feedback that allow information to change, update, or morph according to the User's or Partner's informational requirements or behavior (driven by the User's or Partner's behavior, situation, query criteria, or changes that modify the relevance of the query); (i) There are insufficient methods or instruments that allow the structure, sequencing, and order of the components and sections of the information to change, reorder, or rehash what or how the information is reconciled with the User's or Partner's behavior, according to the User's or Partner's information requirements (driven by the User's or Partner's behavior, situation, query criteria, or changes that modify the relevance of the query); (g) There are no feedback mechanisms that convey to the User or Partner the relevance and accuracy of the information exchanged, as compared to the User's or Partner's Life State, behavior, or situation, which may be delivered through the information.

User and entity data management today heavily relies on methods, ecosystems, software functionalities, and modes of commerce that are disparate, siloed, inaccurate, and fallacious in protecting the rights of such users and entities. This information, and the modes of obtaining, using, sharing, protecting, and altering, are determined by each organization or information ecosystem. These organizations and ecosystems customize the information standards, uses, methodologies, and modes according to their subjective goals and preferences. This has evolved into a state of disorganized, volatile, inaccurate, disjointed, and veiled user/entity information that is virtually impossible to control, harness, and understand from a user/entity perspective. Organizations and ecosystems are also tasked with extravagant methods of obtaining or deriving accurate user/entity information due to these faulty methods. One example of these methods is Google's use of artificial intelligence to rank search results, which derive, learn, and propose the most custom or accurate results. This can be contrasted with a method where a user's/entity's accurate life state information explicitly provides all attributes and allows the most accurate and explicit details of what the user/entity is actually looking for. Another example is Facebook's analysis of user/entity interaction with photos, stories, videos, in order to derive recommendations, advertising, and other informational intersections. This can be contrasted with a method where the user's/entity's up to date and relevant life state information uses attributes with a high degree of validation, accuracy, and breadth, allowing a much higher level of accuracy in providing recommendations. When information is needed outside of the given organization or ecosystem, the current methods use artificial intelligence, statistics, and other methods, combined with an incomplete collection of actual behavioral data from the user/entity. Since almost every aspect of actual user/entity behavior is available and required when increasing the accuracy of information provided to a user/entity, AI alone will always be inferior in comparison when providing accurate data. Another example of current problems when organizations/ecosystems use user/entity data is privacy rights. Current modes of obtaining privacy rights are allusive at best, and unethical/illegal at their worst. Over-generalized acceptance pop ups, cookies, phishing, and unconscionable privacy disclaimers are used to obtain a user's entity's rights. It is seldom the case that the user/entity understands or is aware how their information is being used.

### SUMMARY OF THE INVENTION

This can be contrasted with the defined and structured methods of a user/entity determining how, when, and to what extent all of their information may or may not be used; and then organizations/ecosystems simply access the user's entity's rules for information access at the time the information may be exchanged. Furthermore, the disclosed design allows users to offer their information for sale and purchase. Another example is the method that devices change their behavior, user interactions, and functionalities according to the user's behavior. The current mode of device/user customization is done either by user-entered configurations/preferences or some levels of basic machine learning. The problem with these methods is that they are limited to user input and/or user/device interactions within the user/device experience. Since people and organizations are complex entities, this limited scope leaves out many key attributes in determining a device's customization. The disclosed information model centralizes all behavior, while allowing it to provide the device the maximum amount of user data, organized in a usable structure, so the device can provide the most accurate customization for the user. The disclosed centralized, accurate, and up to date information model allows the highest degree of completeness and accuracy for a user's/entity's information, as well as user security, permissions, and different modes for transacting/accessing such information.

Embodiments of the invention fully utilize the information about a user's life to enable intelligent exchanging of filtered and customized information, through dynamically changing areas within the life state, according to the changes in the user's life, to the users. The information about the user's life is also referred to as a life state, while enabling artificial intelligence methodologies, behavioral analysis, and predictive behavior, the information may be determined, filtered used, displayed, ordered, or filtered, and is referred to as an Intelligent life state. The intelligent life state may consist of many categories, which are dynamically exchanged and updated by the intelligent life state. A user may intelligently or automatically grant partners access to the user's intelligent life state by setting intelligent security features and gatekeeping features. As will be described, embodiments of the present invention may include an intelligent information delivery system that delivers intelligently queried and filtered information to the users. The intelligent information exchange system may enable partners to have access to the users' intelligent life states, as allowed in intelligent settings, configurations, or options between the users and the partners, which may be determined by intelligent methods of determining user behavior, predictive behavior, or predictive user settings. Each user may be associated with a unique intelligent life state. The intelligent life state may be used as a collection of intelligent filters or queries, or as a basis for customized information services (e.g., medical data, entertainment preferences or behavior, web site parameters, marketing data, emails, etc.). Embodiments of the invention may also include an architecture that may include a centralized server computer system connected to the Internet and configured to exchange information between users and partners. The centralized server computer system may be referred to herein as an intelligent information delivery server. The intelligent information delivery server may be configured to provide the users an intelligent life state interface to enable intelligent determinations of user and partner values for the attributes and sub-attributes associated with their intelligent life states. The intelligent information delivery server may be coupled with a database configured to intelligently store the values for the attributes and the sub-attributes. The intelligent information delivery server may be configured to provide the users an intelligent interface to configure portals, views, device depictions, reality depictions, or interactions, which are referred to as the users' life view, virtual or augmented reality, or robotic interactions. The users may use their intelligent life view, virtual or augmented reality, or robotic interactions to view intelligently filtered information. The intelligent information delivery server may be configured to provide the users an intelligent interface to configure a marketplace, which may allow intelligent purchases, grants, and parametrized exchanges of user information, which may be between users and partners. Such intelligent marketplace interfaces are referred to as an intelligent information marketplace. The intelligent information delivery server may also be configured to enable the users and the partners to intelligently rate one another. Replication may be involved to make access, information exchange, and update operations by the intelligent information delivery server more efficient.

For some embodiments, a method to enable a system to store, manage, grow, learn, provide, or build a user's information, or a user (or partner) to receive information that is stored, grouped, filtered, enhanced, or delivered to provide a true or accurate depiction of the user's life or life activities, at a given point in time, is disclosed. A user may indicate an individual person, a group of people, or an organization of people. This enhanced, relevant, or specific information about the user's life may be referred to as the user's intelligent life state. The user's intelligent life state may manage various forms of determining or learning a user's behavior, such as a user's actual behavioral data, simulated behavioral data, training behavioral data, predictive behavioral data, or other forms of learning, such as reinforcement, transfer, self-supervised, unsupervised, curriculum, meta, human feedback, neuromorphic computing, or any form otherwise of learning. The user's intelligent life state may encompass many aspects related to the user, which may include demographic, ethnic, social, economic, social, or psychological aspects. The user may provide or define the user's intelligent life state, or the system may monitor, learn, define, store, manage, filter, use, improve, protect, control, or deliver a user's intelligent life state information. The user may grant approved partners access to the user's life state including associated attributes and sub-attributes. The partners may be approved based on their ability to filter or use its information that is consistent with the user's intelligent life state, at volume and frequency levels that may be specified by the user or by learning or simulation. The user may selectively block a partner from having access to portions or all of the user's intelligent life state. The user may be able to rate a partner based on whether the information provided by the partner is aligned with, or relevant to, the user's intelligent life state. The partner may be able to rate the user based on whether the user's behavior is aligned with the user's intelligent life state. The filtered information may be pulled from the partners or a user's actual behavior, managed, improved, learned, and structured as part of the user's intelligent life state. The intelligent life state information may be presented to the user or 3^{rd} parties, according to user consent and parameters, via some embodiments, which may include various devices, appliances, and systems.

For some embodiments, a method to enable a user to manage an information life view that may be based on intelligently filtered information that dynamically structures and displays the information about the user's life according to the information that may represent the user's behavior at any given point in time. The life view may determine, filter, manage, or structure accurate and aligned information regarding the user's life state, and may be referred to as the user's intelligent life view. The user's intelligent life view may include many categorical information zones related to the user's life view, based on filters in areas such as demographic, ethnic, social or psychological aspects. The user's behavior or defined settings may be used as part of the intelligent life view. The user's behavior or settings may also define which categorical areas display, how the information changes, and criteria that determines how the categorical zones dynamically change. The user's behavior or settings may specify the categories, layouts, and information to change according to the user's life view, which may be based on the underlying Information Delivery System. The information category layouts and content may be prioritized based on user settings or behavior that determines relevance, accuracy, timing, preference, or alignment scores derived from the underlying Information Delivery System, and other intelligent life view parameters (for example, the user's behavior or settings can configure future events and important dates to dynamically trigger layout changes to display content relevant to these dates and events as they approach the current date). The user's behavior or settings may also define time-phased rotation of information categories, which may be based on location, date, time, season, events, years, career states, or geography. This embodiment may interface with the underlying Information Delivery System to allow users to rate the alignment for the information delivered to the intelligent life view. The intelligent life view information is presented to, and modified by, the user's behavior or settings, via the user's intelligent life view settings or some embodiments may also include various devices, appliances, and systems.

To this end, in an exemplary embodiment, a computer-implemented method, comprising: receiving, determining, prioritizing, positioning, and displaying information about or relevant to a user's life, as a registered member of an information delivery system, wherein the information about and relevant to the user's life may include (a) demographic information, (b) ethnic information, (c) social information, or (d) psychological information; enabling the user to grant permissions to a partner to access the information about and relevant to the user's life, wherein the partner is also a registered member of the information delivery system, and wherein the user may grant the permission to the partner by controlling visibility of the partner to the information about and relevant to the user's life and by controlling frequency, extent, type, timing, or volume of filtered information that is accessed or used by the partner, in order for the partner to display customized information relevant to the user's intelligent life view; and receiving the filtered information from the partner, wherein the filtered information is generated by the partner based on applying the information about and relevant to the user's intelligent life to information of the partner, wherein the information about and relevant to the user's life is provided by the user's behavior or settings using a client computing system associated with the information delivery system, wherein the information about and relevant to the user's life is received by a server computing system associated with the information delivery system, and wherein the information about the user's life may be determined, received, prioritized, positioned, or displayed according to the user's life.

In another exemplary embodiment, wherein the user and the partner are registered with the information delivery system, and wherein the information delivery system may be further configured by using simulation or learning to (a) receive or use updated information about the user's life from the user via a computing device or digital interaction, or (b) enable the partner to access information about the user's life to customize partner systems or user experiences according to the information about the user's life; or (c) enable the user to access, update, and interact with a user life view or partner systems or user experiences via a computing device.

In another exemplary embodiment, comprising providing an intelligent life view that may enable the user to view the filtered information, wherein the filtered information may be a subset of the information of the partner, and wherein the intelligent life view associated with the user may be independently configurable from a life view associated with another user of the information delivery system.

In another exemplary embodiment, comprising: establishing a data structure to enable the system to capture and organize user behavior, or a user to provide, the information about or relevant to the user's life, the data structure may include fields related to one another, wherein each of the fields is associated with a value, and wherein the data structure may include multiple levels such that a field at a lower level is to provide more detail information and value than a corresponding field at a higher level. Wherein information may be displayed, prioritized, and positioned in a life view from multiple levels according to the user's life.

In another exemplary embodiment, comprising automatically learning from the user's behavior which values that may be most accurate or relevant. Wherein various methods of artificial intelligence and learning may be used to ascertain a true depiction of the user's behavior. Wherein the fields may be populated with such values; and enabling the system or user to update the baseline values to accurately reflect the user's life. Wherein information may be displayed, prioritized, and positioned in an intelligent life view from multiple levels according to the user's life.

In another exemplary embodiment, comprising automatically learning from the user's behavior which values that may be most accurate or relevant using a mobile computing system or a mobile application associated with the information delivery system. Wherein information may be displayed, prioritized, or positioned in an intelligent life view on a computing system, mobile application, and by other embodiments herein.

In another exemplary embodiment, comprising enabling the user to rate the partner based on whether the filtered information from the partner is aligned with the information about or relevant to the user's life; and enabling the partner to rate the user based on whether the information about and relevant to the user's life is aligned with behavior of the user when the user interacts with partner systems or data. Wherein the user rating for the partner may be used as a setting in the user's prioritization, positioning, or displaying of that partner's information in an intelligent life view. Wherein the partner rating for the user may be visible in the user's prioritization, positioning, or displaying of that partner's information in a life view.

In another exemplary embodiment, comprising storing the information about or relevant to the user's life and intelligent life view in a secured relational database associated with the information delivery system; and enabling the information about or relevant to the user's life to be accessed by the partner when the user interacts with a partner system; or enabling the information about and relevant to the user's life to be customized and accessed by the user through the user's intelligent life view.

In another exemplary embodiment, wherein customized system interactions may be presented to the user when the user interacts with a system of the partner, or wherein the customized system interaction are generated by the partner based on the information about or relevant to the user's life. Wherein the user may interact with these systems directly or from an intelligent life view.

In another exemplary embodiment, wherein filtered search results may be presented to the user when the user interacts with a search engine or website or interacts with the website of the partner, and wherein the filtered search results are generated by the search engine or partner based on search parameters provided by the user. Wherein the interaction may be based on the information about or relevant to the user's life. Wherein the search parameters or search results generated by the search engine or partner may be factored into the partner or search engine information.

Still another exemplary embodiment, a computer-readable media that may store instructions, which when executed by a machine, cause the machine to perform operations comprising: managing, contributing, deriving, sending, or receiving information about a user's life from a user who is a registered member of an information delivery system, wherein the information about the user's life may include demographic, ethnic, social, economic, or psychological information; enabling the user to set parameters to control (a) access to the information about the user's life by a partner and (b) volume and frequency of information to be used by the partner on behalf of the user, wherein the partner may also be a registered member of the information delivery system; receiving the filtered information from the partner, wherein the filtered information may be generated by applying the parameters to information of the partner; and prioritizing, positioning, and presenting the filtered information to a user intelligent life view.

In another exemplary embodiment, wherein the user further sets the parameters to control (a) frequency of receiving the filtered information from the partner, or (b) priority, order, and customized filtering of information to be delivered to a user intelligent life view based on the user's life and display preferences.

In another exemplary embodiment, comprising: establishing a data structure that may enable the user to provide the information about the user's life, the data structure may include fields related to one another, wherein each of the fields may be associated with a value representing one aspect of the user's life; automatically populating the fields of the data structure with a set of values based on actual, simulated, or learned behavior; enabling the user to automatically update the values to more accurately reflect the user's life; enabling the user to rate the partner based on whether the customized partner system experience may be aligned with the information about the user's life; or enabling the partner to rate the user based on whether the information about the user's life may be aligned with behavior of the user when the user interacts with a partner system; or presenting the values, and the partner and user ratings, in a user intelligent life view, according to the user's prioritization, positioning, or custom display settings.

In another exemplary embodiment, comprising: providing a marketplace for the partner or other users to purchase information about a user's life; and enabling the partner to use the information about the user's life to customize user experiences with partner systems when the user interacts with a system of a partner; and enabling marketplace information to be displayed in a user intelligent life view, according to priority, positioning, or custom display settings; or enabling a user to interact with or use marketplace information in the user's intelligent life view. The marketplace information may be based on an underlying life state.

In another exemplary embodiment, wherein the partner may use procured or obtained actual, simulated, learned, or modeled user data enabling the partner to use the information about users' lives to customize user experiences with the partner systems when the users interact with a system of the partner; and enabling marketplace information to be displayed in a user's intelligent life view. Wherein a partner's access to specific user information may be managed by gatekeeping and security controls within the information delivery system.

In another exemplary embodiment, wherein the marketplace may be an auction-based marketplace, wherein the customized partner systems or search engines may include functionality that integrate user behavior that is associated with a customized partner system or search engine, and wherein the customized intelligent life view may include learned, enhanced, filtered, prioritized, or positioned information, or custom settings associated with an intelligent life state, marketplace, or life view.

In another exemplary embodiment, comprising: enabling the user to cause the values of the fields of the data structure to be updated using user-defined updates, learning, simulations, or other means, a mobile application associated with the information delivery system; and wherein the user may access, interact with, or modify settings for an intelligent life view according to the embodiments herein.

In another exemplary embodiment, wherein a mobile application may be configured to enable the user to provide user experience or to cause one or more values of the fields of the data structure to be updated according to user-defined updates, learning, simulations, or other means; and wherein the updated information and user experience may be accessed, updated, and interacted with in a user's life view.

Still in another exemplary embodiment, a system, comprising: an information delivery server connected to a network, the information delivery server may be configured to: (a) enable a user to cause one or more values of the fields of the data structure to be updated according to user-defined updates, learning, simulations, or other means; and wherein the updated information and user experience may be accessed, updated, and interacted with in a user's life view, wherein the information about the user's life may include demographic, ethnic, social and psychological information, and wherein the information about the user's life is stored in a database coupled with the information delivery server, the client computing system connected to the network; (b) enable the user to set parameters that may be updated according to user-defined preferences, learning, simulations, or other means that control the access, use, or display of information about the user's life by or for a partner, which may include volume and frequency of information to be received from a partner on behalf of the user, wherein the information received from the partner may be aligned with the information about the user's life, and wherein the partner may be associated with a partner server connected to the network; (c) by use of user or partner defined updates, learning, simulations, or other means provide the partner with information, assessments, or recommendations based on whether behavior of the user when the user interacts with a system or website of the partner is aligned with the information about the user's life; (d) by use of user or partner defined updates, learning, simulations, or other means provide the user with information, assessments, or recommendations based on whether the information received from the partner is aligned with the information about the user's life; and (e) enable the user to access, update, or interact with a user life view, which may contain custom information, customized according to the embodiments herein, wherein the custom information may be further customized by prioritizing, positioning, and other custom settings, which may occur by defined updates, learning, simulations, or other means, that may change how the information is displayed to a user in a user life view.

In another exemplary embodiment, a system, comprising: an information marketplace wherein the user and the partner may be registered with the information delivery server, and wherein the information marketplace may be further configured to (a) provide a marketplace to enable the partner to purchase the information about the user's life or (b) provide a life, virtual reality, augmented reality, or robotic interactions to present the information received from the partner to the user according to priorities, positioning settings, or other user defined settings, or (c) provide a system where transactions may include the users' compensation for allowing the partners to access the users' life state, the partners may bid against one another to determine the right to access the users' life state information, wherein the system may use defined updates, learning, simulations, or other means be configured to define transactions and determine purchase and buying amounts, and how the user's life state may be used, enabling partners to integrate user information during interactions with the user, or with other parties.

In another exemplary embodiment, an information delivery system comprising; an information marketplace where the user information may be comprised of many sellers or users, and buyers, where information may be organized by information category sections, custom category sections, or dynamic category sections, attributes, or sub-attributes, where such sub-attributes may continue to further define additional sub-attributes. Each category section may consist of many attributes, and each attribute may consist of many sub-attributes. Categories, attributes, and sub-attributes may enhance or further define each other.

In another exemplary embodiment, an information delivery system comprising; an information marketplace where user information may be updated using information from defined updates, learning, simulations, or other means of actual data updates from the user's life behavior to the user's life state information.

In another exemplary embodiment, an information delivery system comprising; an information marketplace where the extent a user's behavior matches the user's life state information, may be evaluated, assessed, or rated. Further in this embodiment, the extent that the user's life state information may reflect future behavior may be evaluated, assessed, or rated, which may be further used in providing projections, predictions, or assessments in the future value or potential value of such user life state information.

In another exemplary embodiment, an information delivery system comprising; an information marketplace where user security and gatekeeping settings may interact with the marketplace, controlling which categories, attributes, and sub-attributes may be accessed in the information marketplace and how such categories, attributes, and sub-attributes may be transacted.

In another exemplary embodiment, an information delivery system comprising; an information marketplace where user interactions with partner systems or customer experiences are transacted and may include user compensation for allowing the partners to access the users' life state at the point of such interaction, where the partners may bid against one another to determine the right to access the users' life state information during these interactions, wherein the system may use defined updates, learning, simulations, or other means be configured to define transactions and determine purchase and buying amounts, and how the user's life state may be used, enabling partners to integrate user information according during interactions with the user, or with other parties.

### BRIEF DESCRIPTION OF THE DRAWINGS

The multiple drawings refer to the embodiments of the invention. While embodiments of the invention described herein is subject to various modifications and alternative forms, specific embodiments thereof have been shown by way of example in the drawings and will herein be described in detail.

FIG. 1 illustrates one example of a computing device that may be used, in accordance with some embodiments.

FIG. 2 illustrates an example of a network that may be used to manage filtered information, in accordance with some embodiments.

FIG. 3A illustrates an example structure of the Intelligent life state categories, attributes, sub attributes, security, filtering, and learning, in accordance with some embodiments.

FIG. 3B illustrates an example of intelligent life state categories, attributes, sub attributes, and intelligent behavioral alignment and predictive behavior, in accordance with some embodiments.

FIG. 3C illustrates an example of accessing the life state, intelligent filtering, data training, and intelligent behavioral data assessment, in accordance with some embodiments.

FIG. 3D illustrates an example diagram of an intelligent group of partners, partner data, life states, and learning, in accordance with some embodiments.

FIG. 3E illustrates an example diagram of the intelligent life state, behavioral alignment assessment, and behavioral data updates, in accordance with some embodiments.

FIG. 3F illustrates an example of intelligent assessment of partner delivered information relevance, as compared to the intelligent life state predictive and actual behavior, with changes to ratings and partner's ability to deliver or derive information, in accordance with some embodiments.

FIG. 3G illustrates an example of an intelligent life state's use of categories, attributes, sub-attributes, security, and gatekeeping, with some embodiments.

FIG. 3H illustrates an example of associating a user with an intelligent life state, intelligent life state settings and parameters, enabling partner and user interactions, and dynamic changes to the intelligent life state, with some embodiments.

FIG. 3I illustrates an example of an intelligent life state application, and some embodiments.

FIG. 4A illustrates an example structure of the Intelligent life view/VR/AR, and intelligent positioning states, in accordance with some embodiments.

FIG. 4B illustrates an example of a collection life view/VR/AR and intelligent positioning and prioritization, in accordance with some embodiments.

FIG. 4C illustrates an example of accessing the life view/VR/AR, intelligent positioning and prioritization, and data training, in accordance with some embodiments.

FIG. 4D illustrates an example diagram of an intelligent group of partners and learning, in accordance with some embodiments.

FIG. 4E illustrates an example diagram of the life view/VR/AR, intelligent partner data, intelligent categories/attributes/sub-attributes, intelligent positioning and prioritization, actual and predictive learning, in accordance with some embodiments.

FIG. 4F illustrates an example diagram of Life State Categories, Attributes, intelligent security and gatekeeping, learning, and the life view/VR/AR, in accordance with some embodiments.

FIG. 4G illustrates an example Life View/VR/AR security and gatekeeping application, Life State Categories, Attributes, and Sub-Attributes settings; positioning and prioritization settings, intelligent security and gatekeeping settings, Life View/VR/AR parameters, in accordance with some embodiments.

FIG. 4H illustrates an example Life View/VR/AR layout application, Life State Categories, Attributes, and Sub-Attributes settings; positioning and prioritization settings, intelligent layout settings, Life View/VR/AR parameters, in accordance with some embodiments.

FIG. 4I illustrates an example of intelligent assessment of partner delivered and displayed information relevance, as compared to the intelligent life state predictive and actual behavior, with changes to ratings and partner's ability to deliver, derive, or display information, in accordance with some embodiments.

FIG. 4J illustrates an example of a life view/VR/AR/robotic interactive application, and some embodiments.

FIG. 5A illustrates an example structure of the Intelligent marketplace, attributes, sub attributes, security, filtering, and learning, in accordance with some embodiments.

FIG. 5B illustrates an example of intelligent marketplace categories, attributes, sub attributes, and intelligent transaction offers, and procurement, in accordance with some embodiments.

FIG. 5C illustrates an example of intelligent marketplace categories, attributes, sub attributes, and intelligent transaction bids and offers, and transactions, in accordance with some embodiments.

FIG. 5D illustrates an example diagram of an intelligent marketplace, partners, information offered, bids, and learning, in accordance with some embodiments.

FIG. 5E illustrates an example diagram of an intelligent marketplace, partner and user aligned, information offered, bids, and learning, in accordance with some embodiments.

FIG. 5F illustrates an example of intelligent filtering of user category and attribute information offers, as relevant to intelligent 3^{rd} party bids, and transactions, in accordance with some embodiments.

FIG. 5G illustrates an example structure of a partner intelligent bid, including intelligent transaction parameters, predictive behavior, or actual behavior, or category, attribute, or sub attribute information, in accordance with some embodiments.

FIG. 5H illustrates an example of intelligent assessment of user stored category, attribute, sub attribute information, and user's actual behavior; whereas variances in user's actual behavior may be updated, in accordance with some embodiments.

FIG. 5I illustrates an example of associating a user with an intelligent information marketplace, intelligent information marketplace settings and parameters, enabling partner and user transactions, with some embodiments.

FIG. 5J illustrates an example of an intelligent marketplace application, and some embodiments.

### DETAILED DESCRIPTION

For some embodiments, a method for intelligent managed and delivered information is disclosed. The method comprises intelligently enabling a user to register and become a member of an intelligent life state based on custom user attributes and delivered information. Information is based on intelligent parameters that determine or that the user provides about the user's life, which is also known as a life state. The user's life state may span many areas including demographic information, ethnic information, social information, behavioral information, and psychological information. The user may intelligently grant partners permission to deliver information to the user's intelligent life state. The partners are also members of the intelligent information delivery system, which in sum are intelligently allowed to deliver information to the user's intelligent life state. The partners may intelligently use the user's life state to filter information for the user.

For some embodiments, a method for displaying intelligent delivered information life view, virtual/augmented reality, or robotic interactions are disclosed. The method comprises intelligently enabling a user to register and become a member of intelligent life view and virtual/augmented reality or robotic interactions based on custom user attributes and information. Information is based on parameters intelligently determined or that the user may provide about the user's life, which is also known as a life state. The user's life state may span many areas including demographic information, ethnic information, social information, behavioral information, and psychological information. The user may intelligently grant partners permission to deliver information to the user's intelligent life view, virtual/augmented reality, or robotic interactions. The partners are also members of the intelligent information delivery system, which in sum are intelligently allowed to deliver information to the user's intelligent life view, virtual/augmented reality, or robotic interactions. The partners may intelligently use the user's life view, virtual/augmented reality, or robotic interactions to filter information for the user. The virtual/augmented reality, robotic, or machine-based interactions may be modified, customized, learned, predicted, or analyzed in a way that allows the user's interactions with said virtual/augmented reality, robotic, or machine-based robotics or devices to match the user's actual behavior, needs, or wants.

For some embodiments, a method for transacting intelligent information is disclosed. The method comprises intelligently enabling users and partners to intelligently buy, sell, grant access to, and exchange information based on custom user attributes and partner parameters. Information is based on intelligently determined parameters or information that the user provides, about the user's life, which is also known as a life state. The user's life state may span many areas including demographic information, ethnic information, social information, behavioral information, and psychological information. The partners may intelligently transact users' life state information and permission to intelligently access and deliver information to the user's intelligent life state, intelligent life view, virtual/augmented reality, and robotic interactions. The partners are also members of the intelligent information delivery system, which in sum are intelligently allowed to transact information with the user's intelligent life view, virtual/augmented reality, or robotic interactions. The partners may intelligently use the user's life view, virtual/augmented, or robotic interactions to access user information.

In the following description, numerous specific details are set forth, such as examples of specific data signals, components, connections, displays, configurations, etc. in order to provide a thorough understanding of the present invention. It will be apparent, however, to one skilled in the art that the present invention may be practiced without these specific details. In other instances, well known components or methods have not been described in detail but rather in block diagrams in order to avoid unnecessarily obscuring the present invention. Thus, the specific details set forth are merely exemplary. The specific details may be varied from and still be contemplated to be within the spirit and scope of the present invention.

The present invention also relates to apparatus for performing the operations herein. This apparatus may be specifically constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled with a computing system bus. Portions of any modules or components described herein may be implemented in lines of code in software, configured logic gates in software, or a combination of both, and the portions implemented in software are tangibly stored on a computer readable storage medium.

The algorithms and displays presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description below.

In the following description of exemplary embodiments, reference is made to the accompanying drawings that form a part hereof, and in which it is shown by way of illustration specific embodiments in which the invention can be practiced. It is to be understood that other embodiments can be used, and structural changes can be made without departing from the scope of the embodiments of this invention. As used herein, the terms “couple,” “connect,” and “attach” are interchangeable and include various forms of connecting one part to another either directly or indirectly. Also, it should be appreciated that one or more structural features described in one embodiment could be implemented in a different embodiment, even if not specifically mentioned as being a feature thereof.

### Computer System

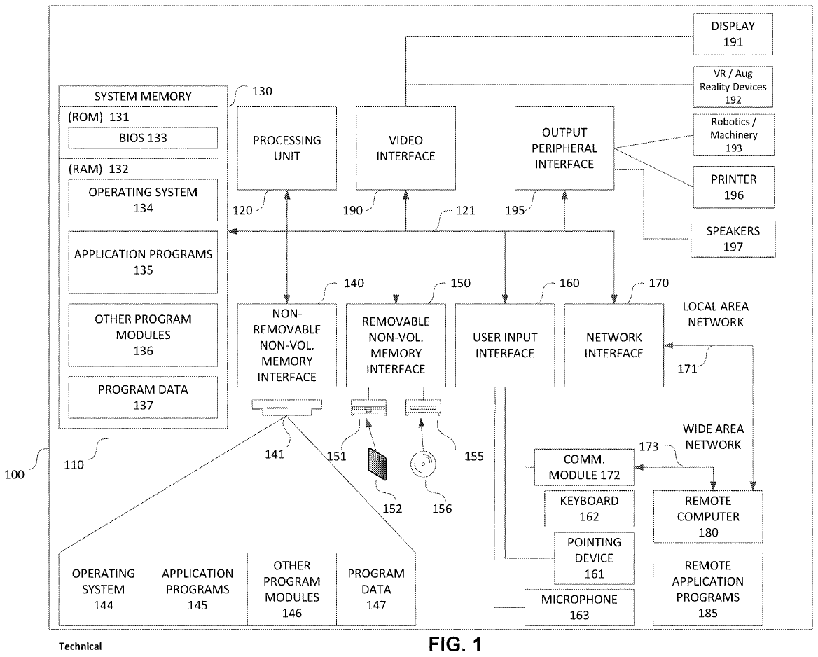

FIG. 1 illustrates a block diagram of an example computing system that may use an embodiment of one or more of the software applications discussed herein, in accordance with some example embodiments. The computing system environment 100 is only one example of a suitable computing environment, such as a client device, and is not intended to suggest any limitation as to the scope of use or functionality of the design. Neither should the computing environment 100 be interpreted as having any dependency or requirement relating to any one or combination of components illustrated in the exemplary operating environment 100. Embodiments of the invention may be implemented on any type of computer, device, apparatus, or even machine that makes use of the computer environment 100. For example, the device may be a medical device that displays the user's medical history or current conditions.

The design is operational with numerous other general purpose or special purpose computing system environments or configurations. Examples of well-known computing systems, environments, and/or configurations that may be suitable for use with the design include, but are not limited to, personal computers, server computers, hand-held or laptop devices, virtual reality or augmented reality systems, robotics, multiprocessor systems, microprocessor-based systems, set top boxes, programmable consumer electronics, network PCs, minicomputers, mainframe computers, distributed computing environments that include any of the above systems or devices, automotive and informational appliances, and the like.

The design may be described in the general context of computing device executable instructions, such as program modules, being executed by a computer. Generally, the program modules include routines, programs, objects, components, data structures, etc., that perform particular tasks or implement particular abstract data types. Those skilled in the art can implement the description and/or figures herein as computer-executable instructions, which can be embodied on any form of computing machine readable media discussed below.

The design may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary computing type system for implementing the design includes a general-purpose computing device in the form of a computing device 110. Components of computing device 110 may include, but are not limited to, a processing unit 120 having one or more processing cores, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus.

Computing device 110 typically includes a variety of computing machine readable media. Computing machine readable media can be any available media that can be accessed by computing device 110 and includes both volatile and nonvolatile media, removable and non-removable media. By way of example, and not limitation, computing machine-readable mediums use include storage of information, such as computer readable instructions, data structures, program modules or other data. Computer storage mediums include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computer 110. Communication media typically embodies computer readable instructions, data structures, program modules, or other transport mechanisms and includes any information delivery media.

The system memory 130 includes computer storage media in the form of volatile and/or nonvolatile memory such as read only memory (ROM) 131 and random-access memory (RAM) 132. A basic input/output system 133 (BIOS), containing the basic routines that help to transfer information between elements within computing device 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computing device 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computing device 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computing device 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but they may be connected by other interface and bus structures, such as a parallel port, game port or a universal serial bus (USB). A monitor or display 191 or other type of display device is also connected to the system bus 121 via an interface, such as a video interface 190. In addition to the monitor, computers may also include other peripheral output devices such as speakers 197 and printer 196, which may be connected through an output peripheral interface 190. Virtual/augmented reality devices 192 or robotics/machinery 193 may also be connected to the system bus 121 via an interface, such as an output peripheral interface 195. The computing device 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computing device 110. The logical connections depicted in FIG. 1 include a local area network (LAN) 1 7 1 and a wide area network (WAN) 173 but may also include other networks. Such networking environments are commonplace in offices, enterprise-wide computer networks, intranets, extranets, and the Internet. A browser application may be resident on the computing device and stored in the memory.

When used in a LAN networking environment, the computing device 110 is connected to the LAN 171 through a network interface or adapter 170. When used in a WAN networking environment, the computing device 110 typically includes a communication module 172 or other means for establishing communications over the WAN 173, such as the Internet. The communication module 172 may be a modem used for wired, wireless communication or both. The communication module 172 may be internal or external, may be connected to the system bus 121 via the user-input interface 160, or other appropriate mechanism. In a networked environment, program modules depicted relative to the computing device 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that the present design can be carried out on a computing system such as that described with respect to FIG. 1. However, the present design can be carried out on a server, a computer devoted to message handling, or on a distributed system in which different portions of the present design are carried out on different parts of the distributed computing system.

Another device that may be coupled to bus 111 is a power supply such as a battery and Alternating Current adapter circuit. As discussed above, the DC power supply may be a battery, a fuel cell, or similar DC power source that needs to be recharged on a periodic basis. For wireless communication, the communication module 172 may employ a Wireless Application Protocol to establish a wireless communication channel. The communication module 172 may implement a wireless networking standard such as Institute of Electrical and Electronics Engineers (IEEE) 802. 1 1 standard, IEEE std. 802. 11-1999, published by IEEE in 1999. Other wireless communication methods that may also be used may include Bluetooth, Radio Frequency, etc.

While other systems may use, in an independent manner, various components that may be used in the design, a comprehensive, integrated system that addresses the multiple advertising system points of vulnerability described herein does not exist. Examples of mobile computing devices may be a laptop computer, a cell phone, a personal digital assistant, or other similar device with on board processing power and wireless communications ability that is powered by a Direct Current (DC) power source that supplies DC voltage to the mobile device and that is solely within the mobile computing device and needs to be recharged on a periodic basis, such as a fuel cell or a battery.

It is possible for some embodiments of the invention to have a computing environment 1 00 that entails memory and display functions without a processing function. For example, a partner may provide customized information to a user, which is relayed to a device for display only with no data manipulation necessary.

### Network Environment

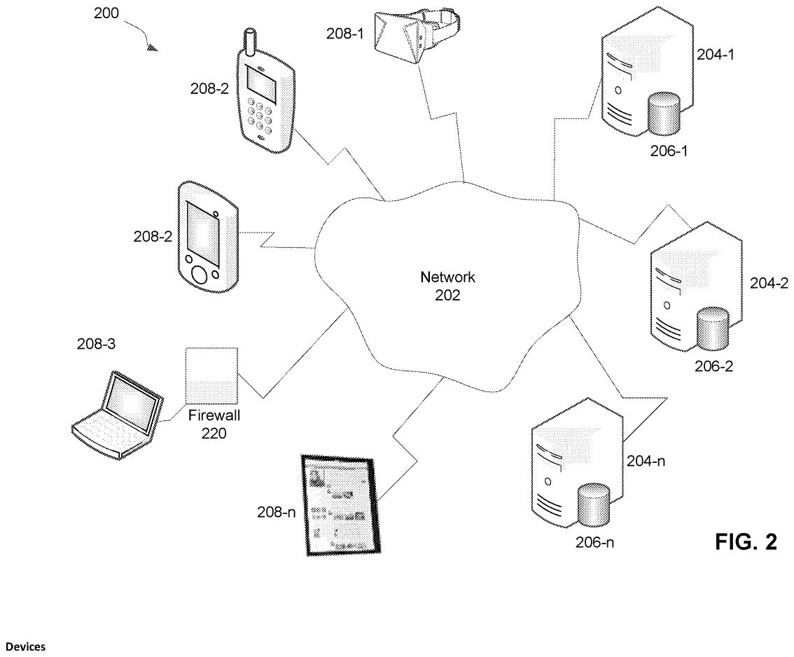

FIG. 2 illustrates a network environment 200 in which the techniques described may be applied, in accordance with some example embodiments. The network environment 200 has a network 202 that connects server computing systems 204-1 through 204-n, and at least one or more client computing systems 208-1. As shown, there may be many server computing systems 204-1 through 204-n and many client computing systems 208-1 through 208-n connected to each other via a network 202, which may be, for example, the Internet. Note, that alternatively the network 202 might be or include one or more of: an optical network, the Internet, a Local Area Network (LAN), Wide Area Network (WAN), satellite link, fiber network, cable network, or a combination of these and/or others. It is to be further appreciated that the use of the terms client computing system and server computing system is for clarity in specifying who initiates a communication (the client computing system) and who responds (the server computing system). No hierarchy is implied unless explicitly stated. Both functions may be in a single communicating device, in which case the client-server and server-client relationship may be viewed as peer-to-peer. Thus, if two systems such as the client computing system 208-1 and the server computing system 204-1 can both initiate and respond to communications, their communication may be viewed as peer-to-peer. Likewise, communications between the client computing systems 204-1, 204-2 and the server computing systems 208-1, 208-2 may be viewed as peer-to-peer if each such communicating device is capable of initiation and response to communication. One or more of the server computing systems 204-1 to 204-n may be associated with a database such as, for example, the databases 206-1 to 206-n. A firewall such as, for example, the firewall 220 between a client computing system 208-3 and the network 202, may be used to protect data integrity. Another firewall example is the firewall 221 positioned between the server 204-2 and the network 202. Although not shown, other devices (e.g., proxy servers, etc.) may also be connected to the network 202.

FIG. 2 also illustrates a block diagram of an embodiment of a server computing system to display information, such as a web page, etc. A user via a browser from the client computing system 208-1 may interact with the web page, and then supply input to the query/fields and/or service presented by a user interface of the application. The web page may be served by a web server computing system 204-1 on any Hypertext Markup Language (HTML) or Wireless Access Protocol (WAP) enabled client computing system 208-1 or any equivalent thereof. For example, the client mobile computing system 208-1 may be a smart phone, a touch pad, a laptop, a netbook, etc. The client computing system 208-1 may host a browser to interact with the server computing system 204-1. Each application, widget, plug-in, etc. has a code scripted to perform the functions that the software component is coded to carry out such as presenting fields and icons to take details of desired information. The intelligent life state applications may be hosted on the server computing system 204-1 and served to the browser of the client computing system 208-1. The applications then serve pages that allow entry of details and further pages that allow entry of more details.

Any application and other scripted code components may be stored on a computing machine readable medium which, when executed on the server causes the server to perform those functions. In an embodiment, the software used to facilitate the functions and processes described herein can be embodied onto a computing machine readable medium such as computer readable medium. As discussed above a computing machine readable medium includes any mechanism that provides (e.g., stores) information in a form readable by a machine (e.g., a computer). For example, a computing machine readable medium includes read only memory (ROM); random access memory (RAM); magnetic disk storage media; optical storage media; flash memory devices; DVD's, EPROMs, EEPROMs, FLASH, magnetic or optical cards, or any type of media suitable for storing electronic instructions. The information representing the apparatuses and/or methods stored on the computing machine readable medium may be used in the process of creating the apparatuses and/or methods described herein.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms may be written in a number of different software programming languages such as C, C++, SQL, Java, or other variants of such or similar languages. Also, an algorithm may be implemented with lines of code in software, configured logic gates in software, or a combination of both. In an embodiment, the logic consists of electronic circuits that follow the rules of Boolean Logic, software that contain patterns of instructions, or any combination of both.

It should be noted that the configuration of the diagram illustrated in FIG. 2 is for illustrative purposes only, and the actual configurations may vary. There might be different configurations of servers, firewalls, clients, and devices. For example, the devices may be anything from iPads, to automobiles, to TV devices, and so on.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computing system, or similar electronic computing device, that manipulates and transforms data represented as physical (electronic) quantities within the computing system's registers and memories into other data similarly represented as physical quantities within the computing system memories or registers, or other such information storage, transmission or display devices.

### AI Environment

The exemplary hardware components used for the AI aspects of this invention are selected to enhance the speed and accuracy of the computations. AI hardware for processors may include FPGAs (field programmable gate arrays), GPUs (graphic processing units), wafer-scale engines, NPUs (Neural processing units), and TPUs (Tensor processing units). Any of these processors may be combined with the appropriate supporting circuits to compute the AI algorithms needed to implement those aspects of this invention.

### Intelligent Life State

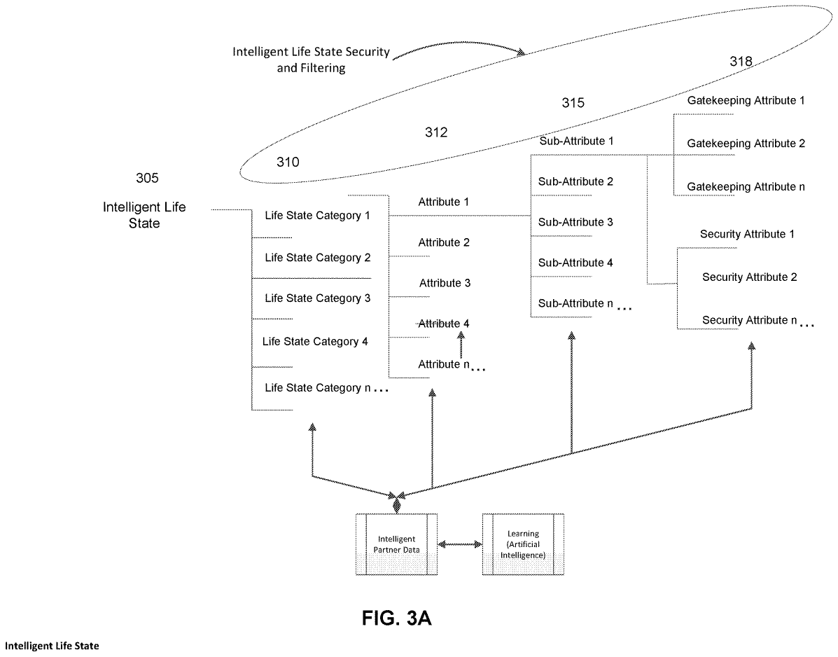

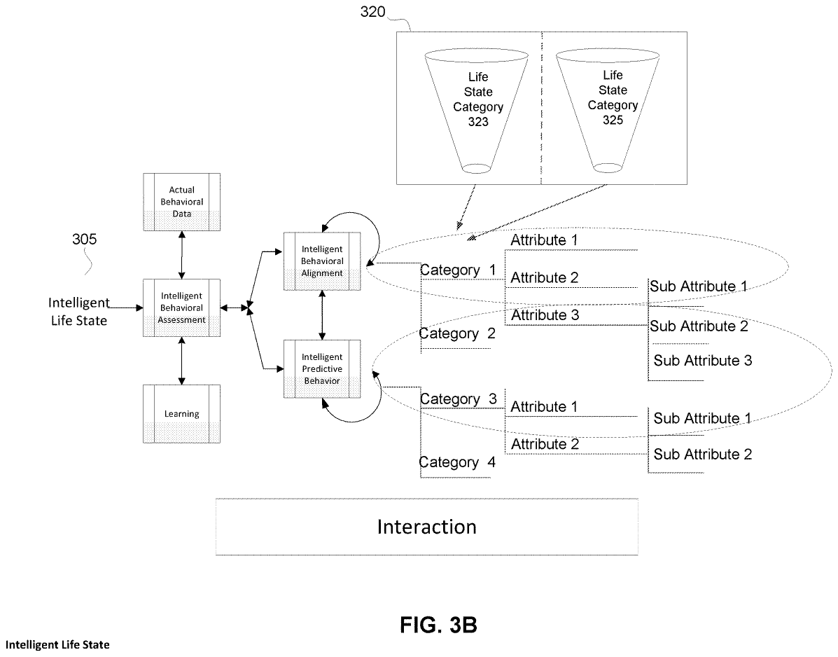

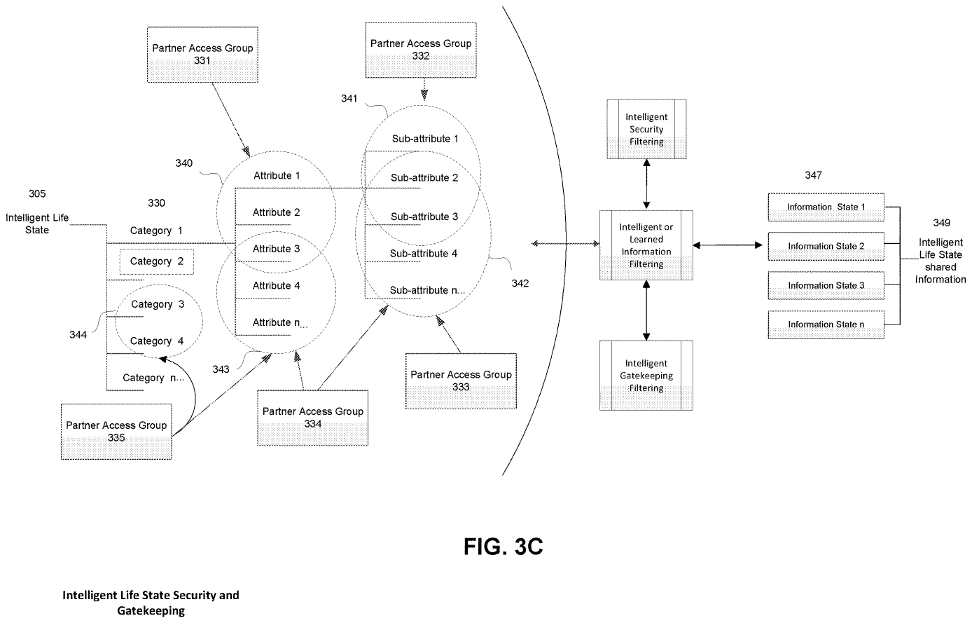

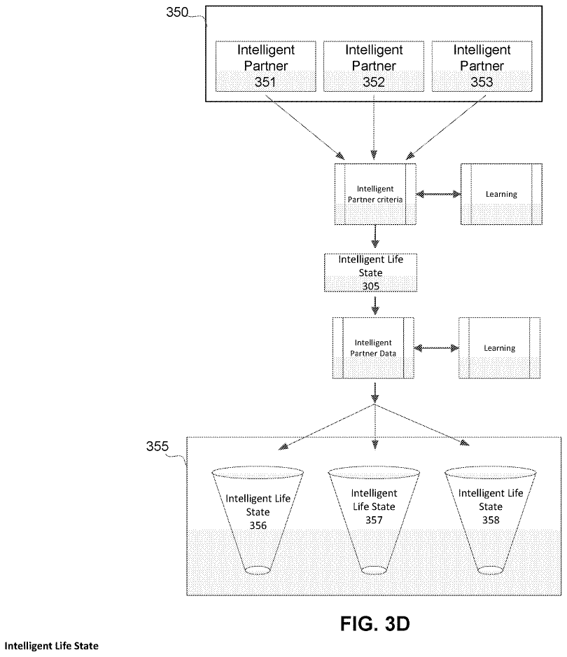

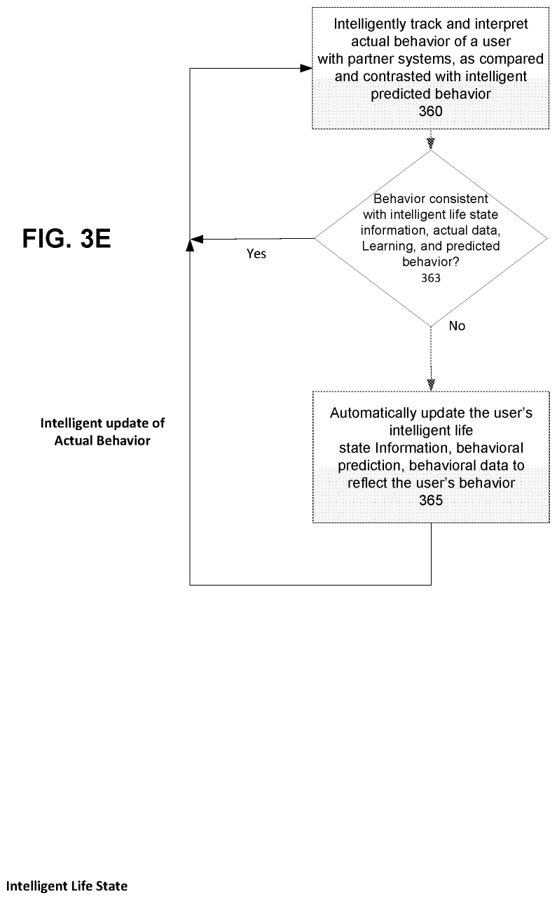

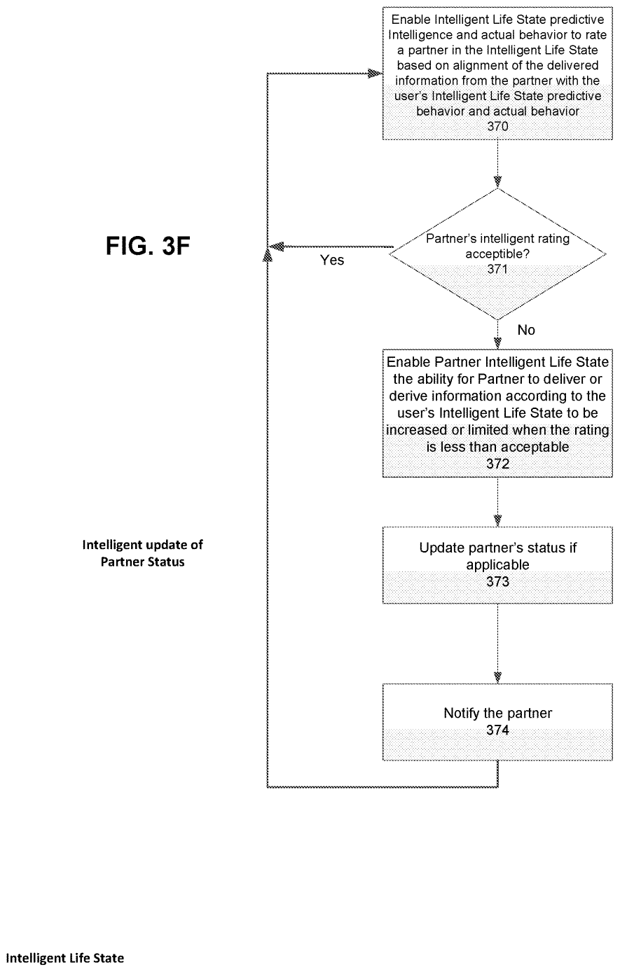

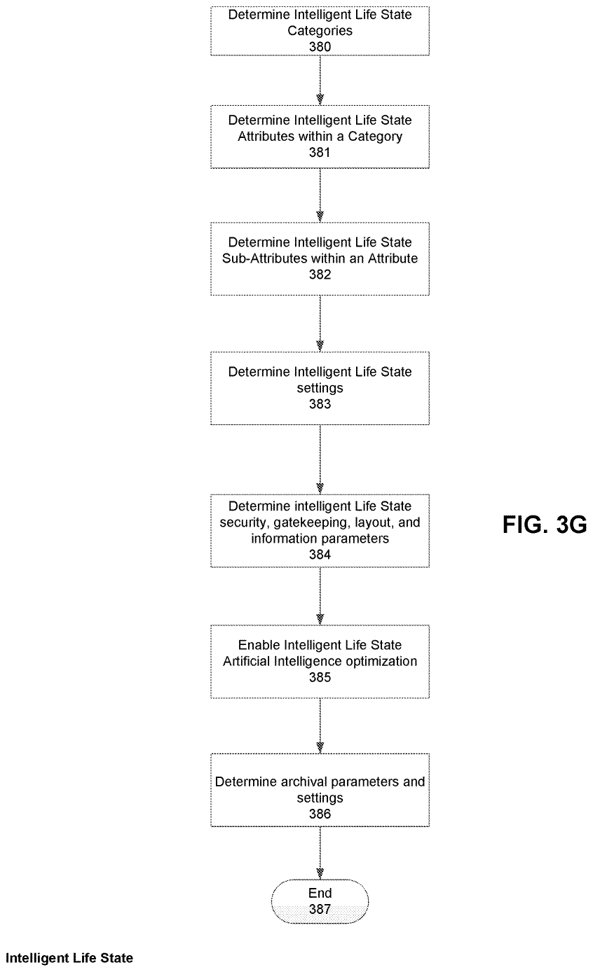

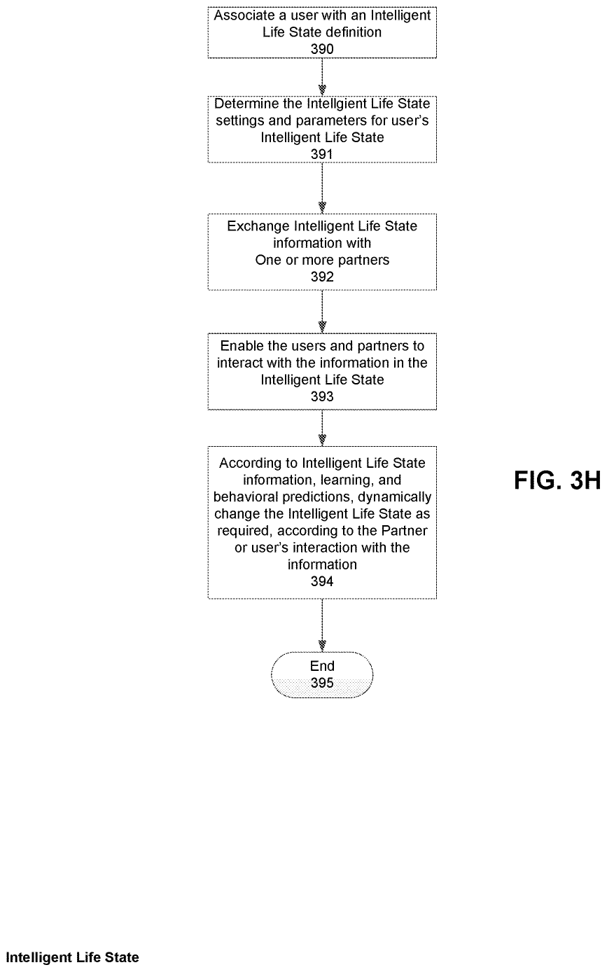

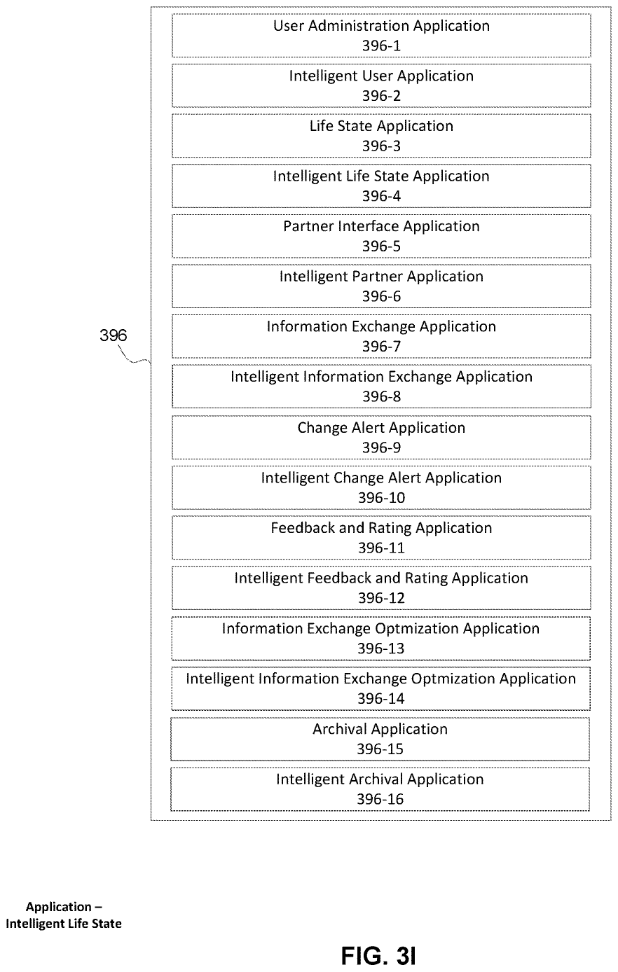

FIG. 3A illustrates an example structure of an intelligent life state, in accordance with some embodiments. A life state may be associated with many categories. Each category may consist of many attributes. Each attribute may consist of many sub-attributes. Together, the categories, attributes, or the sub-attributes may conceptually describe who the user is from many different views. The categories, attributes and sub-attributes may be related to one another in a top-down relationship or laterally-enhancing the interpretations of each attribute value. The categories, attributes, or the sub-attributes may be defined by means of artificial intelligence or by an administrator or a management team of the information delivery system. In some embodiments, they may also be defined by industry authorities, 3^{rd} parties, or partner artificial intelligence. Each of the attributes or sub-attributes may be associated with a value. Embodiments of the present invention enable artificial intelligence or the users to maintain or control the setting of values of the attributes or sub-attributes. The values may be in any format including, for example, data, text, qualitative, Boolean yes/no, numeric, objects, etc.

Referring to FIG. 3A, the intelligent life state 305 may consist of multiple categories 310. It is envisaged that each of the many aspects of a user's life can be intelligently mapped to a category of the life state 305. Each of the categories 310 may consist of many attributes 312 and sub-attributes 315. Although not illustrated, each of the sub-attributes 315 may consist of many deeper levels of sub-attributes. For example, under the sub-attribute 1, there may be sub-attribute 1.1, sub-attribute 1.2, etc. The categories, attributes, and/or sub-attributes may be dynamic and managed by the intelligent life state, may be managed by an administrator, or managed by a combination of the intelligent life state and the manager. For example, new categories, attributes, or sub-attributes may be intelligently added, removed, or changed; an attribute under one category may be moved to another category, a new category may be created, an existing attribute may be removed, etc. The ability to intelligently update the categories, the attributes or the sub-attributes illustrate the dynamic nature of the life state.

Following are some possible categories, attributes, and sub-attributes. There may be a category “lifestyle.” Under this category, there may be attributes “travel”, “past time”, and “life balance.” Under the attribute “travel”, there may be the sub-attribute “local” and the sub-attribute “preferred mode of transportation”, and the deeper sub-attribute “automotive.” Under the category “entertainment”, there may be several attributes such as “sports”, “music”, “movies”, “games”, “attractions”, “cultural events”, “gambling”, etc. Under the attribute “sports”, there may be a sub-attribute such as “football”, and under the deeper sub-attribute “football type”, there may be lower level of sub-attributes such as “football”, “golf”, etc. A value for the sub-attribute “football” may be “favorite team”, which may have a lower-level sub-attribute of “Los Angeles Rams”. A value for the attribute “music” may be “favorite genres”, which may have a lower-level sub-attribute of “alternative rock”, “hard rock”, and “alternative rock”. The number of categories, attributes and sub-attributes may be large since they together describe the users' life state.

As the user's life changes, the values for the attributes and/or sub-attributes may be updated. For example, the value for the attribute “marital status” may be changed from “single” to “married.” The values for the attributes and sub-attributes may be automatically provided or derived. Other possible categories, attributes, or sub-attributes may include, but are not limited to: ‘lifestyle”, “political”, “social”, “technology skills”, “entertainment”, “career”, “goals”, “education.” The number combinations of categories, attributes, or sub-attributes (and deeper levels of sub-attributes) may be extensive and may represent a snapshot of the life of a user. It may be noted that this is different from the traditional user profile used by current systems since the information included in a traditional user profile is very limited and does not accurately depict the user's life state. An option may be provided to enable the users to select using the automatic setting of values using artificial intelligence to accurately align actual behavior with the intelligent life state. For example, a new user may select this option to speed up the processing or increase the accuracy of the user's intelligent life state. The information delivery server or computer or device may be configured to provide automated compilation of intelligent user behavioral data, interview tools, wizards, or applications that gather and map the information about the user to the relevant attributes or sub-attributes.

As depicted in 318, gatekeeping and security attributes may be used to control information exchanged between users and partners. Security attributes may determine how categories, attributes, or sub-attributes are accessed. Gatekeeping attributes may determine how categories, attributes, or sub-attributes are accessed by specific partners, as specified by the user.

FIG. 3B illustrates an example of a collection of intelligent life states, in accordance with some embodiments. The collection of life states may represent the intelligent life state categories of many users. In the current example, the collection of intelligent life state categories 320 includes the intelligent life state 305. The funnel shape associated with each of the intelligent life state categories 323 or 325 illustrates the concept of using a life state to intelligently funnel or filter the information available from the partners. The intelligent life state 305 may determine how accurately the user's actual behavior is aligned with the intelligent category, attribute, and sub-attribute values. The life state 305 may predict the user's actual future behavior by using actual behavior, artificial intelligence, or behavioral alignment, which may set or reset the intelligent category, attribute, and sub-attribute values. Typically, most of the information from the partners is not relevant or applicable to the user. The intelligent life state helps to funnel the information available from the partners so that only filtered information that is relevant to the user's intelligent life state is exchanged among the user and the partners. In other words, the intelligent life state may enable the partners and users to exchange the right type of information, at the right time, place, and most accurate depiction.

The life state may also be used in other applications. In the case of the user surfing the web or visiting a web site, the intelligent life state enables the web site or user interaction to display customized or intelligent information that may include matching to what the user is interested in or that is relevant to the user's life. Intelligent life state information may be provided according to the users' intelligent privacy, security, and gatekeeping attributes. In the case of using a search engine, the life state may enhance the search results generated by the search engine and may provide results according to the user's intelligent privacy, security, and gatekeeping attributes.

FIG. 3C illustrates an example of granting access to the intelligent life state, in accordance with some embodiments. This example illustrates an intelligent life state structure similar to the example described with FIG. 3B. As depicted in 305, an intelligent life state may allow a user complete control of how the user's intelligent life state is accessed or granted through the use of intelligent security or gatekeeping. Intelligent security or gatekeeping settings may be derived from a user's actual behavior or by a user's security or gatekeeping settings, or by other means that cause the settings to be determined. Intelligent security may allow the user to determine what user information categories, attributes, or sub-attributes may be shared with other parties. For example, a user may set or derive intelligent security settings at the category level to not allow sharing of any health information. Intelligent gatekeeping may allow the user to determine parameters that may limit or specify the provision of the user's intelligent information for other parties. For example, a user may set or derive a gatekeeping setting to allow mental health information to be shared with specific partners, for a defined period of time only, and only for purposes of mental health provider assistance. Intelligent security may take precedence over the intelligent gatekeeping user settings. The granting of access for a partner may be at the category level, the attribute level, the sub-attribute level, or combinations thereof. A combination of one or more categories, one or more attributes, or one or more sub-attributes is referred to as an access group. Each access group may be viewed as a subset of the intelligent life state. A partner may be granted permission to access one or more partner access groups. It should be noted that the granting of the access isn't just about seeing or using the information associated with the user's intelligent life state, it's also about how the partner accesses or uses the information according to the intelligent security and gate keeping attributes, as depicted in 347. The content of a partner access group or accessing the intelligent information in an access group may vary and may be derived or changed by the user. The information may be accessed, used, displayed, or otherwise presented to the user, as depicted in 349.

As illustrated, the partner 331 is granted access to the partner access group 340 which consists of values associated with some attributes under the category 1. The partner 332 is granted permission to the access group 341 which consists of values associated with some sub-attributes under the attribute 1. The partner 333 is granted permission to the access group 342 which consists of values associated with some sub-attributes under the attribute 1. The partner 334 is granted permission to the access group 343 which may consist of values associated with some attributes under the category 1. The partner 335 may also grant permission to the access group 343. The partner 334 may also be granted permission to the access group 342 which may consist of values associated with some sub-attributes under the attribute 1. The partner 335 is also granted permission to the access group 344 which may consist of values associated with the attributes or sub-attributes under the category 3 and category 4. These intelligent access group or granting permission examples may illustrate some of the flexibilities and control that a user may have with the user's intelligent life state. The directions of the arrows from the partner access groups to the partners may illustrate the granting of the permission by the user to the partners. Each granting of intelligent access groups by intelligent security may be enhanced with intelligent gatekeeping parameters for the user or 3^{rd} parties or partners.

FIG. 3D illustrates an example diagram of a group of intelligent partners, in accordance with some embodiments. The diagram includes intelligent life states similar to the intelligent life state described with FIG. 3C. For some embodiments, a third party may be approved before it may be granted permission to intelligent life state 305 as a partner. A set of criteria may be used to evaluate and approve a third party. The set of criteria may be determined by artificial intelligence, a user, a management team, or an administrator associated with the information delivery system. For example, the criteria may include one or more of the following: the ability of a third party or partner to provide information relevant to the users according to their life states, the type of information, service, merchandise and/or information that the third party or partner is offering and whether they map to the categories, attributes or sub-attributes defined by the intelligent life state structure, the ability of the third party or partner to map its services or information to the intelligent life state structure, the reputation or credibility of the third party or partner, the likelihood that the third party or partner will continue to perform the role context of which it is providing information for, or the third party or partner performing as a market or industry leader in the category/attribute/sub-attribute that it is assigned to, etc. Other criteria may also be used.

Once a third party is approved, it becomes a partner. A license may be granted to the partner. The license may give the partner permission to copy or access the users' intelligent life states for a defined period. There may be an expiration date, where exceeding this date may mean the license may need to be renewed. The intelligent partners may use copies of the intelligent life states to filter or deliver its information, or the intelligent partner may customize its devices, web sites, or digital interactions for the users when the users interact with the partner's organization. The customization of the intelligent partner's organizational digital conduits may be according to the intelligent life states as granted to the intelligent partner by the users. Depending on the actions of a partner, a license may be active, suspended, or revoked. Other license statuses may also be used. Security credentials including user identification (ID) or password or other methodologies may be assigned to an approved intelligent partner. For some embodiments, only those intelligent partners whose status is active may be granted permission to access the users' intelligent life states. There may be different types of partners. For example, an intelligent partner may be an individual, an organization, a governmental agency, a user, etc. The intelligent partners may also be defined based on one or more types of products or services they offer. For example, the type “Search Engines” may be used for Microsoft and Google when they become partners, and the partner type “Sport Organization” may be used when a sports venue may want to access the users' intelligent life states for sport event attendance, locations, etc.

In the current example, block 350 represents all of the intelligent partners. They include the intelligent partners 351, 352 and 353. These partners may have been granted permission to the life state 305. As described with FIG. 3C, the level of permission of each of the intelligent partners 351, 352 and 353 may be different. The directions of the arrows from the partners 351, 352 and 353 to the intelligent life state 305 may illustrate the filtering of the information from the partners. For some embodiments, the partners may exchange actual behavioral information with the users, based on user interactions with the partners' ecosystems or organizations. For some embodiments, partners may use artificial intelligence methodologies to determine or enhance parameters and modes of exchanging information or actual behavioral information to the intelligent life state 305, automatically populating user attributes in the intelligent life state. For example, Amazon.com may exchange information with a user (such as relating to a new technology product releases), technology adoption, asset inventory, etc., and Amazon.com may also exchange information with a user regarding the user's or other user's actual behavior, including purchase history, online shopping search parameters, etc. When an intelligent partner may send information to users' intelligent life states, 355 may depict these life states. As depicted in 355, intelligent partner information may be sent or exchanged with different intelligent life states 356, 357, or 358.

FIG. 3E, as depicted in 360, illustrates intelligent partners that may learn methods to improve accuracy, relevance, and alignment during the process of intelligently accessing and delivering information with an intelligent life state, providing more accuracy and intelligent information alignment when delivering information to that intelligent life state or other intelligent life states. For example, through the compilation and analysis of actual and predictive intelligent user behavior patterns, Amazon.com may learn or determine that a method of providing advertising to an intelligent life state yields a higher degree of accuracy or alignment to indicate future user behavior; and Amazon.com may alter the information it pushes or obtains to or from other intelligent life states to achieve improvements in intelligent behavioral alignment. As depicted in 363, an intelligent partner may also use artificial intelligence to learn how accurate user transactions, predictive information, or actual user behavior is when compared to a user's intelligent life state. As depicted in 365, an intelligent life state may be automatically updated with user-defined, actual, partner provided, learned, or predictive user behavioral categories, attributes, or sub-attributes. For example, a user may allow Amazon to update the user's attributes with actual user purchasing data, which may be used to also update attributes relating to the user's use, research, ownership, procurement, or interests concerning technology products.

FIG. 3F, as depicted in 370, illustrates intelligent partner ratings that may be defined, derived, or learned according to the accuracy of the partner's intelligent delivered information when compared to the user's actual behavior or predictive behavior. As depicted in 371, a partner's rating may be assessed according to information delivery accuracy or as other learned statuses. As depicted in 372, a partner's information delivery may be limited according to the partner's rating. As depicted in 373, a partner's rating may be updated to a status or description according to 371 or 372. A partner may be notified of such rating, as depicted in 374. Various methods may be used in 371, 372, 373, or 374, which may include artificial intelligence, learning, predictive behavior, user or partner settings, or other methods. For example, through the compilation, analysis, or determination of partner information delivery accuracy that may indicate a degree of accuracy of partner delivered information, Amazon.com may be rated in a way that allows more information to be delivered to a user or group of users. Amazon.com may have a rating that illustrates this change and may also receive an update of this change. Examples may use artificial intelligence, learning, or other methods to automatically effectuate these changes.

FIG. 3G as depicted in 380, illustrates how an intelligent life state application may use categories, attributes, sub-attributes, and various settings. As depicted in 380, intelligent life state categories may be user-defined, based on actual behavior, partner provided, learned, predictive, or set otherwise. As depicted in 381, intelligent life state attributes may be user-defined, based on actual behavior, partner provided, learned, predictive, or set otherwise. As depicted in 382, intelligent life state sub-attributes may be user-defined, based on actual behavior, partner provided, learned, predictive, or set otherwise. It should be noted that there is no limit to how many intelligent life state categories, attributes, sub-attributes, or layers of sub-attributes that may be defined. As depicted in 383, intelligent life state settings may be defined to determine how the application may utilize, display, order, filter, exchange, or determine user information. As depicted in 384, intelligent life state security, gatekeeping, or layout settings may be defined to determine how the application may secure, access, or display user information between users and partners. As depicted in 385, intelligent life state optimization may be used to optimize or improve user information accuracy, timing, parameters, actual behavior, predictive behavior, or other aspects of user information, through the use of artificial intelligence. As depicted in 386, intelligent life state archival settings may be used to archive the intelligent life state, information, accuracy, timing, parameters, actual behavior, predictive behavior, or other aspects of user information.

FIG. 3H illustrates how an intelligent life state application may assign a user and optimize the intelligent life state based on user and partner interactions. As depicted in 390, a user may be associated with an intelligent life state definition. There may be multiple intelligent life state definitions for a user or multiple users for an intelligent life state definition. As depicted in 391, various settings or parameters may specify how intelligent life state information, accuracy, timing, parameters, actual behavior, predictive behavior, or other aspects of user information may function. As depicted in 392, life state categories, attribute, or sub-attribute information may be exchanged among the user and partners. As depicted in 393, users and partners may interact with intelligent life state information. For example, a user may interact with offered products or services from one or more partners; or a partner may interact with user information or another partner's information. As depicted in 394, the intelligent life state may be updated according to activities in 391, 392, or 393. Updates may include user-defined values, actual behavior, partner provided information, learned behavior, predictive behavior, or other types of informational updates. It should be noted that there is no limit to how many intelligent life state categories, attributes, sub-attributes, or layers of sub-attributes that may be defined, updated, or analyzed through artificial intelligence.

FIG. 3I illustrates example applications that may be used to enable the users or partners to exchange information, in accordance with some embodiments. 3I illustrates applications that may manage a life state or applications that may manage intelligent versions of such applications. Intelligent versions of applications may use artificial intelligence to determine functionality, information, settings, values, or other application components.

The intelligent life state 396 may include a user administration application 396-1, or an intelligent user application 396-2. The intelligent life state 396 may include a life state application 396-3, or an intelligent life state application 396-4. The intelligent life state 395 may include a partner interface 395-5, or an intelligent partner interface 396-6. The intelligent life state 396 may include an information exchange application 396-7, or an intelligent information exchange application 396-8. The intelligent life state 396 may include a change alert application 396-9, or an intelligent change alert application 396-10. The intelligent life state 396 may include a feedback and rating application 396-11, or an intelligent feedback and rating application 396-12. The intelligent life state 396 may include an information exchange optimization application 396-15, or an intelligent exchange optimization application 396-16. The intelligent life state 395 may include an archival application 395-15, or an intelligent archival application 396-16.

It may be noted that even though these applications are described herein as separate applications, the functionalities of one may break down into multiple applications, or two or more of them may be combined into one application. These applications may be used to exchange, set, determine, or derive information from various resources. The resources may include devices, appliances, robotics, internet, web pages, user or partner defined, artificial intelligence, learning, predictive behavior, actual behavior, or other means. For example, a user's intelligent life state may be replicated on devices, appliances, or any means that allows the user to control security, gatekeeping, or other methodologies used to access the user's intelligent life state, the partners to access the user's intelligent life state, or the exchange of information by the partners to the user or on behalf of the user. It may be noted that not every device or appliance used in embodiments of the invention may be an information exchange mechanism. That is, some devices may be registered in the core system to exchange the information, and then the devices may function in the core system or application as a conduit for the exchanging, deriving, managing, sending, or receiving the information.

### Intelligent Life/VR View

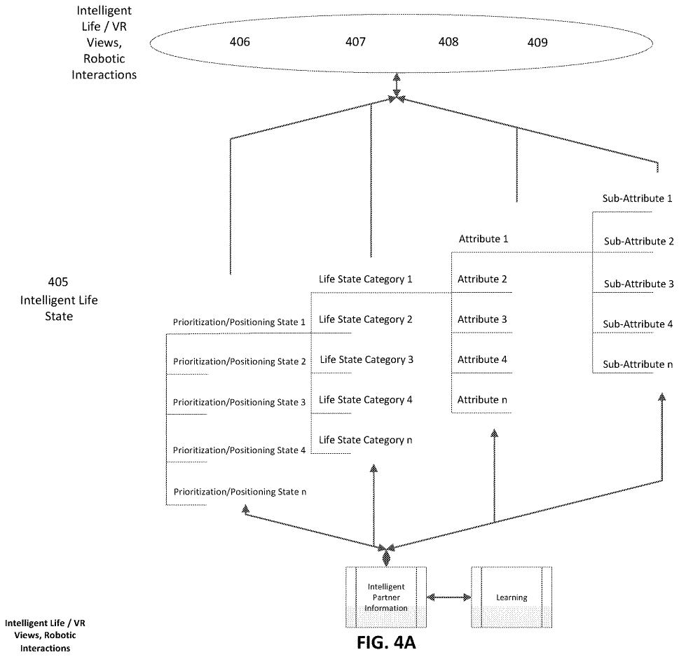

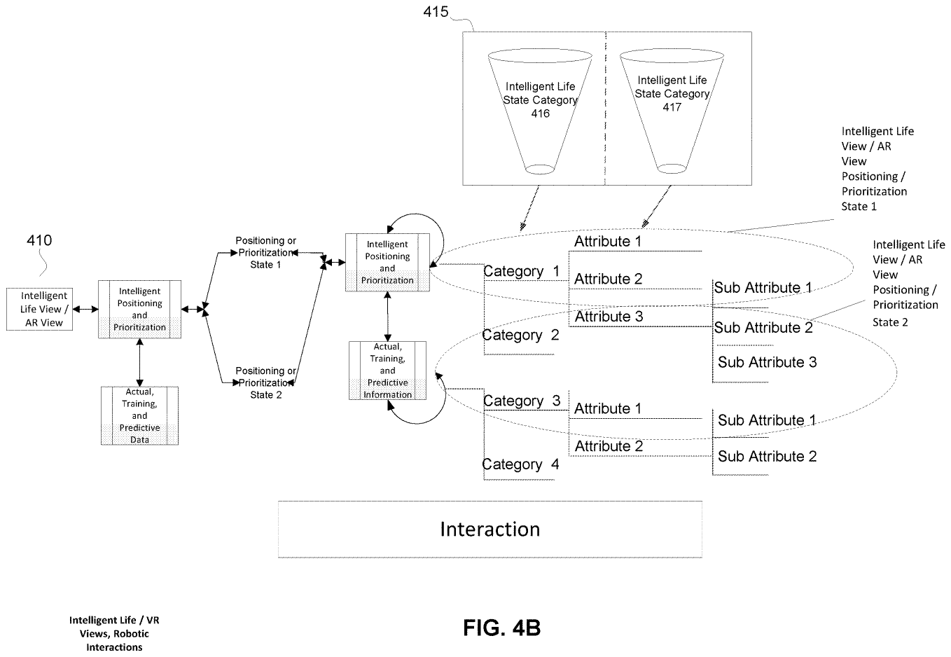

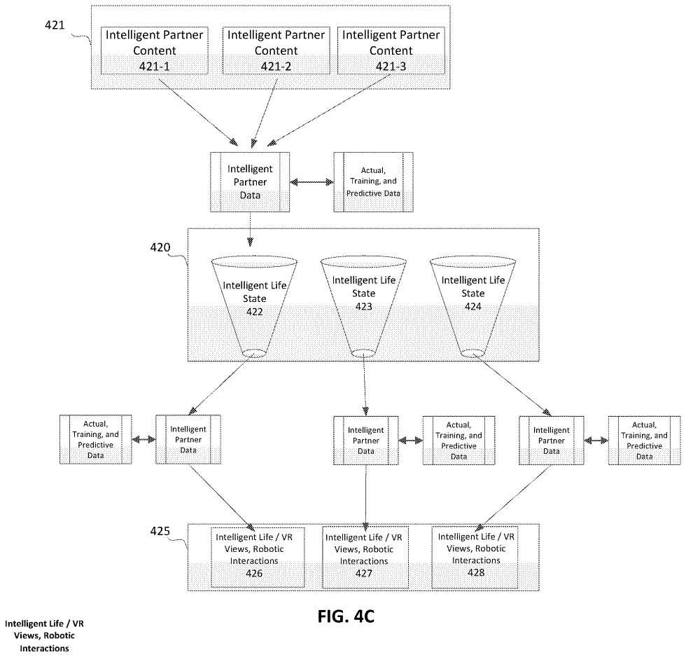

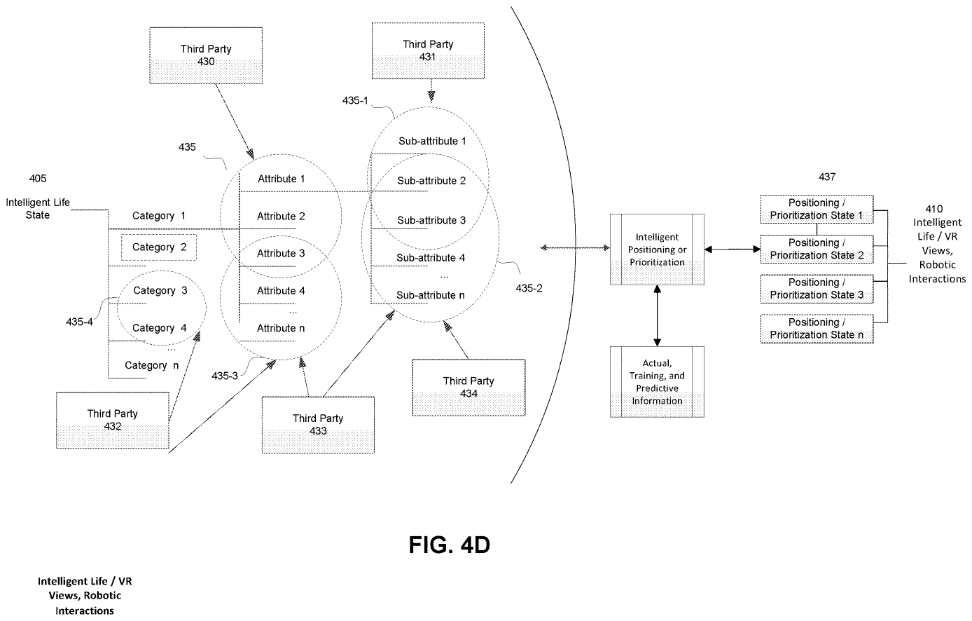

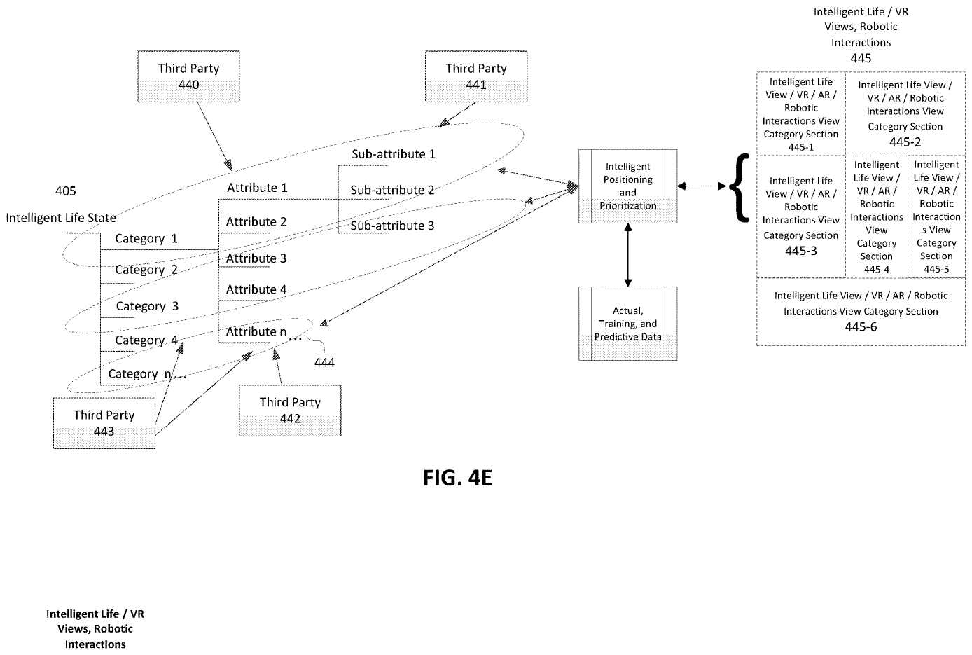

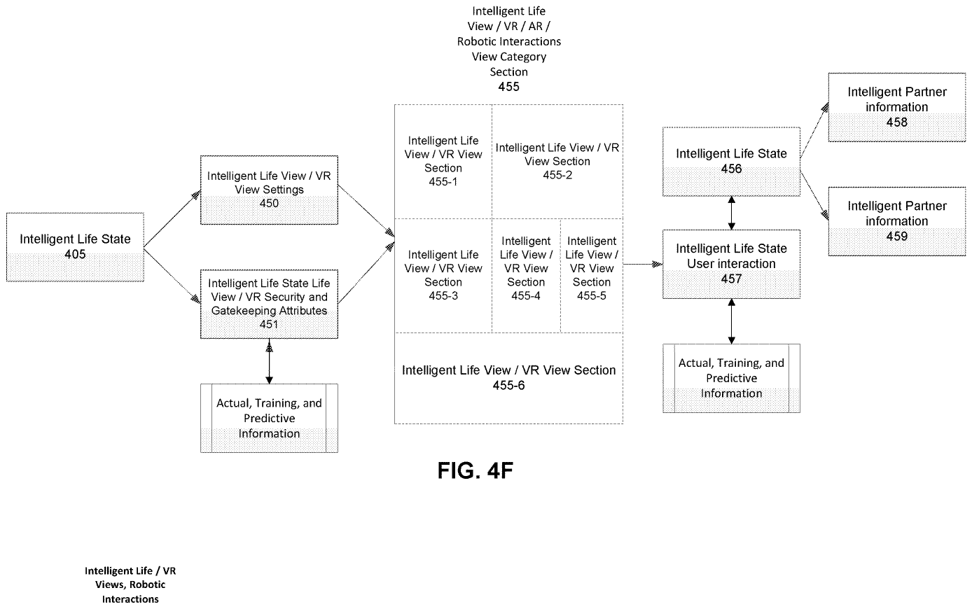

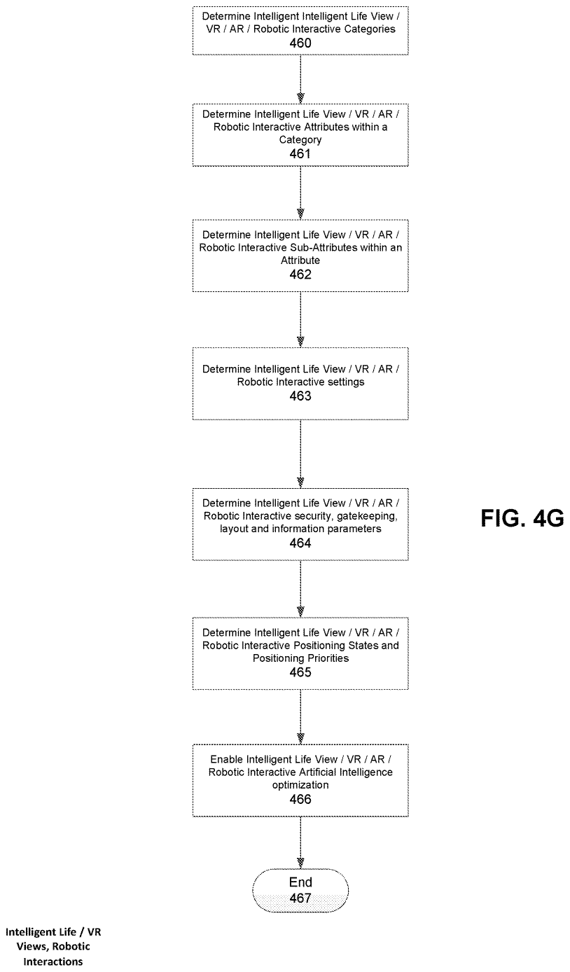

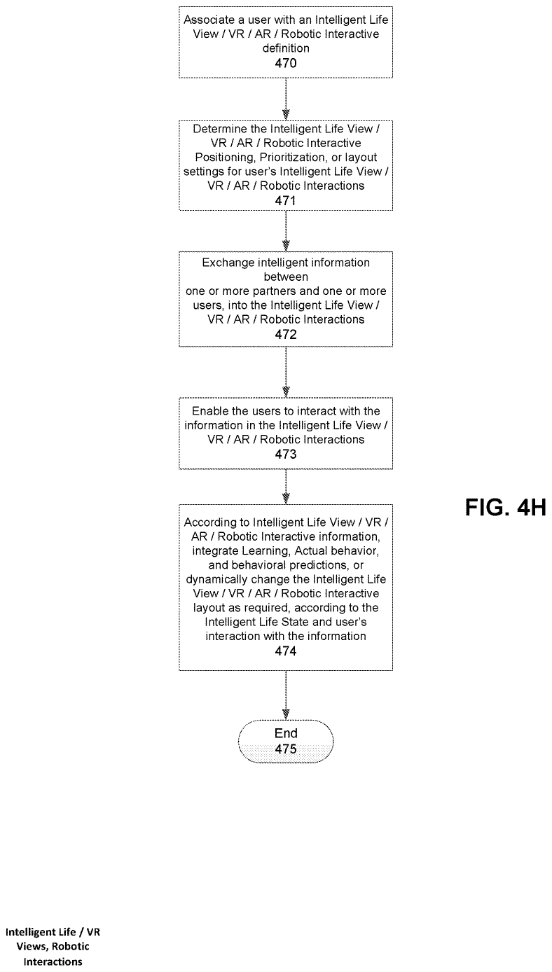

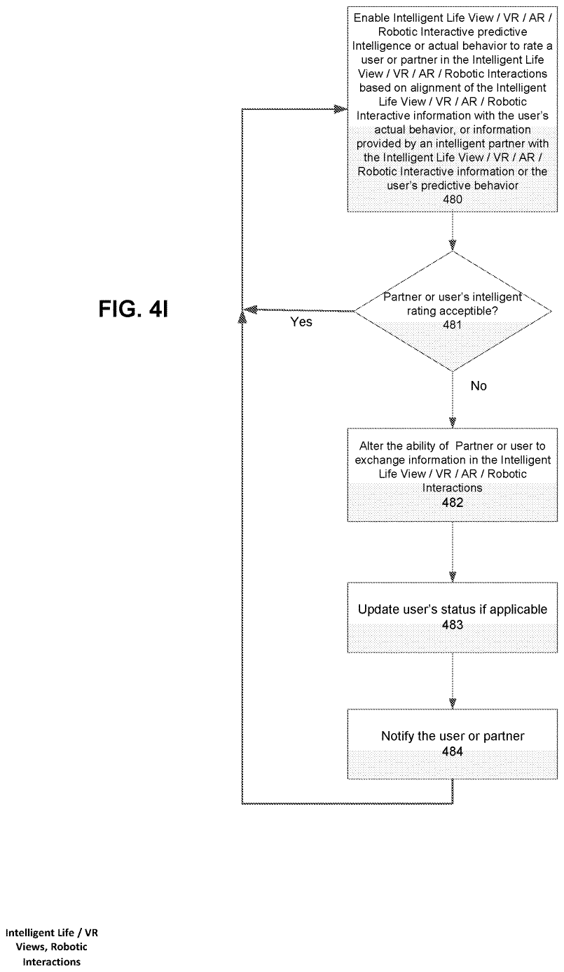

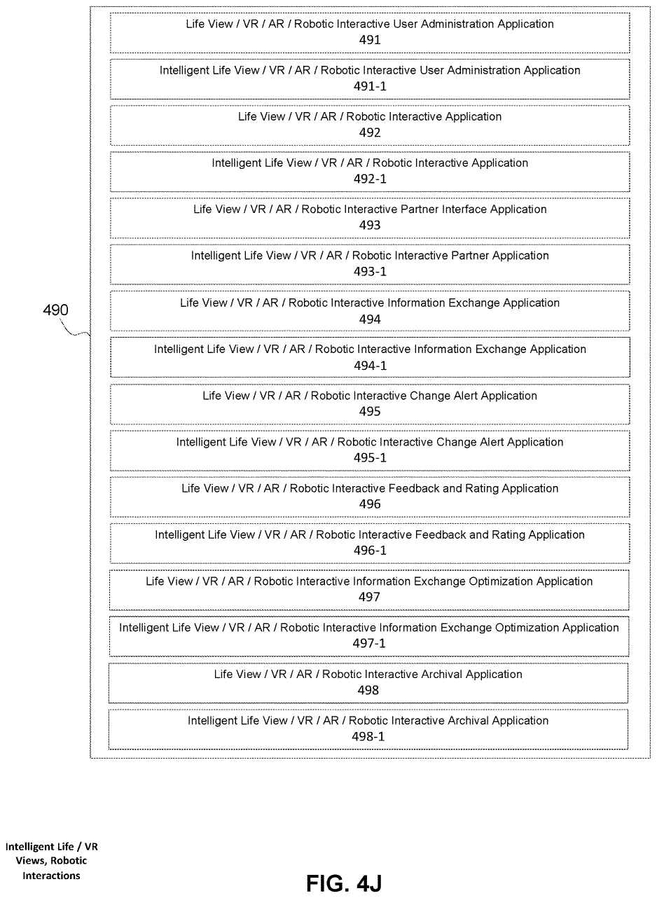

FIG. 4A illustrates an example diagram of a view of a user's information, in accordance with some embodiments. The information delivery server may be configured to deliver the filtered information from the intelligent life state 405 on behalf of the users and may present that information to the user via a personalized view. Each user may be associated with custom views. In the current example, the view 406 may be associated with a life state 405, the life state 405 may be associated with multiple customized views, as depicted in 406, 407, 408, or 409. The number of these associations may be extremely large. Intelligent categories, attributes, and sub-attributes may be used in the intelligent life/VR views. Intelligent prioritization or positioning may be used to allow the intelligent life state information to be more accurate, timely, or relevant. Intelligent prioritization may allow the display of information that is more accurate, timely, or relevant to a specific time in the user's life. Intelligent positioning may allow the display of information to be more accurate or relevant to a specific place, device, computer, or other means of accessing the intelligent life/VR view. To access the filtered information, the users may log in to an information delivery server using their user IDs, passwords, or other modes of access. The filtered information may also be stored as floating variable, cache, memory, etc. on any device or system, which may access the filtered information. The intelligent partner information may be accessed from the intelligent life state, an intelligent information marketplace, or from intelligent life/VR views. The intelligent life/VR view or partner information may be composed of actual behavior, predictive behavior, user settings, partner settings, or other data compiled. The intelligent life/VR view or partner information may utilize learning, which may use artificial intelligence to determine the most optimal information to use in the intelligent life/VR view or intelligent partner information.

FIG. 4B illustrates an example diagram of a view of a user's information, in accordance with some embodiments. The directions of the arrows from the intelligent life/VR view 410 to intelligent positioning or prioritization illustrate the flow of filtered information to the intelligent positioning or prioritization states. An intelligent positioning or prioritization state may be used to depict an intelligent life/VR view in a specific time and place. Intelligent positioning or prioritization states may be static or dynamic. The intelligent positioning or prioritization states may use any combination of intelligent life state category, attributes, or sub-attributes. Intelligent positioning or prioritization states may utilize artificial intelligence, actual behavioral information, predictive information, or other forms of information to provide more accurate or relevant intelligent life/VR view information.

Intelligent life state categories 415 may depict different categories for an intelligent life state. The intelligent life state category 416 may allow the use of one or more categories in the intelligent life/VR view. The intelligent life state category 417 may allow the use of one or more categories, different from the life state categories used in 416, in the intelligent life/VR view. Intelligent positioning or prioritization states 1 or 2 may depict different intelligent life/VR views after more accurate or relevant information may be displayed.

FIG. 4C illustrates the overall concepts of embodiments of the present invention where the collection of life states 420, may use filtered information from the intelligent partners 421 to create custom filtered information (or a subset of the information of the partner), where information may be exchanged between the users and intelligent partners via the intelligent life views 425. There may be many intelligent partners, as depicted in 421-1, 421-2, and 421-3. The number of intelligent partners may be extremely large. There may be many intelligent life states, as depicted in 422, 423, and 424. The number of intelligent life states may be a very large number. There may be many intelligent life views, as depicted in 426, 427, and 428. The number of intelligent life views may be extremely large. For some embodiments, the exchange of the filtered information from or to the partners may be automatic, or use pre-set or specified information, artificial intelligence, actual behavior, training, or predictive information.

FIG. 4D illustrates an example diagram of an intelligent view of a user's information, in accordance with some embodiments. As depicted in 405, an intelligent life state may include categories, attributes, and sub-attributes, that are accessed by partners. Partner 430 may provide information for some categories, attributes, and sub-attributes, as depicted in 435. Partner 431 may provide information for some categories, attributes, and sub-attributes, as depicted in 435-1, and so on. Partners may provide information based on partner information that may be obtained from various methods, which may include methods involving artificial intelligence, learning, uploaded or downloaded bulk information, user defined values, partner defined values, or other forms of obtaining or deriving information. The intelligent life state information may be used by intelligent positioning or prioritization to allow the information to be more accurate or relevant. The intelligent positioning or prioritization may interact with actual, training, or predictive behavioral information, allowing the information to be displayed in a more accurate or relevant manner, as depicted in 437. The positioning or prioritization states may be used by the intelligent life view, to provide more accurate and relevant information, as depicted in 410.

FIG. 4E illustrates an example diagram of an intelligent view of a user's information, in accordance with some embodiments. As depicted in 405, an intelligent life view may contain categories, attributes, or sub-attributes, which may be accessed or updated by third parties. Partners 440, 441, 442, 443, and so on may access or update different subsets of intelligent life state categories, attributes, or sub-attributes. The intelligent life state information may be used by intelligent positioning or prioritization to allow the information to be more accurate or relevant. The intelligent positioning or prioritization may interact with actual, training, or predictive behavioral information, allowing the information to be displayed in a more accurate or relevant manner, which may create sub-sections or multiple subsets of intelligent life view information, as depicted in 445. The sub-sections or subsets of intelligent life view information may be comprised of an entire intelligent life state or grouped in various combinations by intelligent life state or view categories, attributes, or sub-attributes. It should be noted that the groupings may take any form and may be extremely large.

FIG. 4F illustrates an example diagram of an intelligent view of a user's information, in accordance with some embodiments. As depicted in 405, an intelligent life state may access or update intelligent life/VR view information according to intelligent life/VR view settings, as depicted in 450. Intelligent life/VR view settings may determine how an intelligent life view generally functions or interacts with an intelligent life state. For example, a user may use intelligent life/VR view settings to use intelligent life state intelligent security or gatekeeping attributes that are unique for the intelligent life/VR view. Using another example, a user may use intelligent life/VR view settings to use default intelligent life state intelligent security or gatekeeping attributes for the intelligent life/VR view. Also as depicted in 405, an intelligent life state may access or update intelligent life view information according to intelligent security or gatekeeping attributes, as depicted in 451. Intelligent security attributes may determine what intelligent life state information may be shared. For example, a user may use intelligent security settings to keep all medical information private or not shared. Intelligent gatekeeping attributes may determine specific rules that may allow a partner or group of partners to access the user's intelligent life state information, which may contain categories, attributes, or sub-attributes, and may include different subsets of intelligent life state categories, attributes, or sub-attributes. For example, intelligent gatekeeping settings may allow a partner or a defined list of partners to access specific entertainment attributes, for a specific date range. Intelligent security or gatekeeping attributes may be set or managed by using artificial intelligence, intelligent life state or life/VR view settings or values, actual behavior, training information, predictive behavioral information or by other means.

The intelligent life view 455 may display filtered or exchanged information from a partner or group of partners, according to intelligent life/VR view settings, as depicted in 450. The intelligent life view 455 may display filtered or controlled information from a partner or group of partners, according to intelligent security or gatekeeping attributes, as depicted in 451. An intelligent life state 456 may be updated according to a user's interactions with the intelligent life view, as depicted in 457. Intelligent life state settings, values, actual behavior, training information, predictive behavioral information, or other types of user or behavioral information may be used with the intelligent life state user interaction 457 to update the intelligent life state 456. The intelligent life state information may be exchanged with intelligent partner information 458 or with intelligent partner information 459, based on the intelligent life state 456. It should be noted that there may be an extremely large number of intelligent partners or users.

FIG. 4G illustrates example applications that may be used to manage or optimize the filtered information, in accordance with some embodiments. The intelligent life/VR view categories 460 may be defined, derived, loaded from an intelligent life state, or determined using artificial intelligence, learning, actual or predictive behavior. An intelligent life view category may have attributes that relate to the category, as depicted in 461. An intelligent life view attribute may have sub-attributes that relate to the attribute, as depicted in 462. There may be an extremely large number of categories, attributes, or sub-attributes. As depicted in 463, intelligent life view settings may be used to determine how the application manages and filters information, when managing the categories, attributes, and sub-attributes. As depicted in 464, security parameters may be used to determine how the application limits information, which may include categories, attributes, or sub-attributes. Also as depicted in 464, gatekeeping may be used to determine how the application allows partners to access information, which may include categories, attributes, or sub-attributes. Also as depicted in 464, layout or information parameters may be used to determine how the application displays, arranges, or manages the life/VR view application, which may include general settings, display settings, categories, attributes, or sub-attributes. As depicted in 465, intelligent life/VR view positioning states may be used to determine how the application positions, displays, or arranges filtered information, which may include categories, attributes, or sub-attributes. Also as depicted in 465, intelligent life/VR view positioning priorities may be used to determine how the application prioritizes information display, positioning, or arrangement, which may include categories, attributes, or sub-attributes. It may be noted that even though these applications are described herein as separate applications, the functionalities of one may break down into multiple applications, or two or more of them may be combined into one application. These applications may be used to pull, push, exchange, or derive filtered information from various resources. The resources may include devices, appliances, robotics, internet, web pages, user or partner defined, artificial intelligence, learning, predictive behavior, actual behavior, or other means. For example, a user's intelligent life state may be replicated on devices, appliances, or any means that allows the user to control security, gatekeeping, informational exchange or filtration methodologies used to access the user's intelligent life/VR view, the partners to access the user's intelligent life/VR view, or the pushing of the filtered information by the partners to the user or on behalf of the user. It may be noted that not every device or appliance used in embodiments of the invention may be an information exchanging or filtration mechanism. That is, some devices may be registered in the core system to receive information, and then the devices may function in the core system or application as a conduit for the exchanging, deriving, managing, or receiving information.

FIG. 4H illustrates example applications that may be used to process, manage, or optimize the intelligent life view information. As depicted in 470, a user may be associated with an intelligent life view. It should be noted that there may be an extremely large number of intelligent life views for a user. As depicted in 471, various positioning, prioritization, or layout settings may be used to determine the placement, timing, position, or other depictions regarding the presenting of intelligent information in the user's intelligent life/VR view. As depicted in 472, information may be exchanged between partners and users. It is important to note that there may be an extremely large number of partners or users. As depicted in 473, users may be enabled to interact with the information in the intelligent life/VR view. For example, a setting may be made that allows a user's behavior to interact with a category or attribute of the user's intelligent life state; where a setting may disable the user's behavior to interact with another category or attribute. A user's behavior interacting with a category, attribute, or sub-attribute may change, enhance, or alter the information in the user's intelligent life state or information that a partner may provide. In the case of another example, a setting may be made that allows a user's behavior to interact with an entertainment attribute that stores information about the frequency the user attends musical concerts within a defined genre; this setting may allow the intelligent life/VR view to capture, update, or optimize information in real time. In another example, a user may react or enact a behavior that is derived from information in the intelligent life/VR view; for example, a user may interact with intelligent partner information by following a link in the information that allows the user to make a purchase or access an intelligent partner resource. As depicted in 474, additional optimization may be integrated into the life/VR view, which may include artificial intelligence, learning, actual behavior, predictive behavior, or other aspects that may optimize or make the information more accurate, timely, or relevant.

FIG. 4I illustrates example applications that may be used to manage how closely a user's actual behavior is aligned with the user's intelligent life state or intelligent life/VR view, or how closely an intelligent partner's information is aligned with a user's intelligent life state, intelligent life/VR view, or the user's predictive behavior. As depicted in 480, predictive or actual behavior may enable a user or partner to be rated based on the accuracy of the information exchanged. A user may be rated according to how closely the user's actual behavior is aligned with the user's intelligent life state, intelligent life view, or predictive behavior information. An intelligent partner may be rated according to how closely the intelligent partner's information aligns with a user's intelligent life state, intelligent life/VR view, or predictive behavior information. As depicted in 481, the alignment assessment made in 480 may be rated. As depicted in 482, the ability of a user or intelligent partner may be altered in the intelligent life/VR view. For example, if an intelligent partner's information is not aligned with the user's intelligent life state, intelligent life/VR view, or predictive behavior, the intelligent partner may be limited or restricted in providing information to one or more users. In another example, if a user's behavior does not align with their intelligent life state, intelligent life/VR view, or predictive behavior as depicted in 483, a user or partner's status may be updated. It is important to note that a status update may take any form that may alter a user or partner's ability to use, interact with, or manage an intelligent life/VR view. As depicted in 484, a user or intelligent partner may be updated with information regarding alignment assessments, changes to status or alterations of a user or partner's ability to use, interact with, or manage an intelligent life/VR view

FIG. 4J illustrates example applications that may be used to enable or manage an intelligent life/VR view, in accordance with some embodiments. The intelligent life/VR view system 490 may include life/VR view user administration application 491, life/VR view application 492, life/VR view partner interface application 493, life/VR view information exchange application 494, life/VR view change alert application 495, life/VR view feedback and rating application 496, life/VR view information exchange optimization application 497 and life/VR view archival application 498. Each application may have an intelligent component, which may utilize artificial intelligence, learned behavior, actual behavior, predictive behavior, or other various methods to optimize or alter the application settings. These applications for the information delivery system 490 may include Intelligent life/VR view user administration application 491-1, intelligent life/VR view application 492-1, intelligent life/VR view partner interface application 493-1, intelligent life/VR View information exchange application 494-1, intelligent life/VR view change alert application 495-1, intelligent life/VR view feedback and rating application 496-1, intelligent life/VR view information exchange optimization application 497-1 and Intelligent life/VR view archival application 498-1.

It may be noted that even though these applications are described herein as separate applications, the functionalities of two or more of them may be combined into one application. These applications may be used to manage filtered or exchanged information from or to various resources. The resources may include Internet websites. Non-Internet resources may also be used. For example, a user's intelligent life/VR view may be replicated or displayed on devices, appliances, or any means that allows the user to control how to view information, grant permission to the user's intelligent life/VR view, grant intelligent partners access to the user's intelligent life/VR view, or to exchange information with intelligent partners. It may be noted that not every device or appliance used in embodiments of the invention is a filtered information exchange mechanism. That is, some devices may be registered in the core system to receive information, where other devices may only function in the ecosystem as a conduit for the delivering filtered information among the intelligent partners or users.

The user administration applications 491 or 491-1 may be configured to manage the users and the partners, which may include setting up their user accounts, user IDs, passwords, etc. These user accounts may allow the users to participate in the intelligent life/VR view system 490. The user accounts may be stored in the database associated with the intelligent life/VR view system 490. The user accounts of the users may be encrypted or stored locally in the client computing systems. The client computing systems may be appliances, devices, etc. This may enable a partner to recognize a user as a member of the information delivery system or intelligent life/VR view system when the user visits a website or resource associated with the partner. This may enable the partner to keep track of the user's behavior while visiting that website or resource to determine if the user's behavior is aligned with the user's intelligent life state. The user administration applications 491 or 491-1 may also keep track of user type (e.g., user, administrator, etc.), partner type (e.g., individual, organization, etc.), partner category (e.g., content provider, advertiser, etc.), partner status (e.g., active, revoked, suspended, pending, etc.), the type of license granted to the partner, etc. It may be noted that the user may be an individual, an organization, a business, etc.

The life/VR view application 492 or 492-1 may be configured to perform operations associated with forming and maintaining the life/VR view of many users or partners. The life/VR view application 492 or 492-1 may be configured to enable an administrator to define a life/VR view structure including the categories, attributes, sub-attributes, layouts parameters, or other settings. The life/VR view application 492 or 492-1 may be configured to present or display a life/VR view interface to allow the users and partners to exchange information, which may update the values for the attributes and sub-attributes for user intelligent life states.

The life/VR view application 492 or 492-1 may be configured to allow the users or intelligent partners to define how the information is presented when exchanged between a user and partner. The life/VR view application 492 or 492-1 may be configured to provide a layout interface to allow the user or intelligent partner to design the look and feel of information presentation. The layout interface may include parameters to control the fields, links or dimensions of the layout. The user or intelligent partner may define multiple layouts that change according to event rules defined by a user or intelligent partner. For example, the user may define parameters that cause the layout to emphasize financial or economic information when there is a significant swing in the financial market. The life/VR view application 492 or 492-1 may be configured using positioning or prioritization settings. For example, the user may define positioning or prioritization settings to display and emphasize the financial or economic information before other intelligent life/VR view information, and in a physical location that allows immediate viewing. It is important to note that there may be any number of different settings of prioritization or prioritization parameters. The layout interface may allow a user or intelligent partner to define different information regions. Each of the information regions may focus on the information that corresponds to one aspect of the user's life. As mentioned, each user or partner may be associated with a portal, website, or other resource. The user may access a portal, website, or resource by logging into the intelligent life/VR view, which may use an assigned user or partner ID, or password. The system configurations, layouts, or information regions may be stored in a system associated with an intelligent life/VR view system 490.

For some embodiments, the life/VR view application 492 or 492-1 may also be configured to perform consistency verification to determine if user actual behavior is reflected in the user's intelligent life/VR view, intelligent life state, or the respective application settings, parameters, security, or gatekeeping.

The intelligent life/VR view partner interface application 493 or 493-1 may be configured to enable the intelligent life/VR view system to communicate with one or more systems of the partners. For example, this may enable the partners to access the users' intelligent life/VR views, which may include users' definitions, gate keeping, security features, or other settings. This may include interfacing with the partners to enable customized websites or resources, filtered search results, etc.

The life/VR view information exchange application 494 or 494-1 may be configured to exchange intelligent life/VR view information among the users and intelligent partners. The life/VR view information exchange application 494 or 494-1 may also be configured to apply application settings, parameters, security or gate keeping features, which may be set by the user. As described, the intelligent partners may use the user's intelligent life/VR view to customize user information. The life/VR view information exchange application 494 or 494-1 users may receive customized or filtered information from the partners on various partner websites or resources. The intelligent partners may also procure intelligent life state or intelligent life/VR view information via a marketplace.

The change alert application 495 and 495-1 may be configured to notify the partners and the users whenever there is a change that may affect the process of changes in the intelligent life state, intelligent life view, or intelligent partner delivered information. The changes may originate from the partners' and/or users' behavior or activities. For example, the change may include a new value assigned to the user's attributes or sub-attributes regarding the live attendance of a new type of sport the user may be interested in. In another example, the change may be necessary to address complaints or suggestions from many users and/or partners concerning how relevant information delivered to a user or group of users is. The changes may originate from automation, artificial intelligence, actual behavior, planned behavior, predictive behavior, internally by a management team, user settings, partner settings, or by other means. The changes may involve any types of structure, data definitions, values, or system attributes. For example, it may be necessary to add a new category, to move an attribute from one category to another category, to delete an attribute, to change the meaning of a sub-attribute, etc. The changes may also originate externally by other parties. The change alert application 495 and 495-1 may also be configured to notify a partner when a user's life state is modified. Similarly, the change alert application 495 and 495-1 may notify a user when the partner's ability to provide its information is modified.

The life/VR view feedback and rating application 496 and 496-1 may be configured to improve the quality, relevance, or accuracy of the information exchanged or delivered. This may include providing a mechanism to allow users or partners to provide feedback regarding the accuracy of the user's intelligent life state, intelligent life/VR view, or the partners' accuracy of providing information. This may include providing a mechanism to allow the users to rate the partners, as well as a mechanism to allow the partners to rate the users. The rating of the partners is based on whether the filtered information pulled from the partners is aligned with the life states of the users. The rating may also be based on a collection of feedbacks from many users. This may help the partners to fine tune their information delivery methodologies if they receive low ratings. This also helps identifying the partners who consistently fail to improve their information accuracy, relevance, or timeliness. For example, a partner who provides inaccurate advertising information may get a low rating because it may not be relevant to the user's actual behavior. A consequence for a partner who gets a low rating may be a suspension or revocation of its license or ability to provide information for a user or for users. Following are some conceptual examples of the ratings for a partner:
None—The information from the partner may not be aligned with the user's intelligent life state or intelligent life view
Low—The information from the partner may not be minimally aligned with the user's intelligent life state or intelligent life view
Moderate—The information from the partner may be mostly aligned with the user's intelligent life state or intelligent life view
High—The information from the partner may be significantly aligned with the user's intelligent life state or intelligent life view

In order for a user to receive accurate information, it may be necessary for the user to keep the user's intelligent life state or intelligent life view updated by utilizing artificial intelligence, learning, or other methods, or to utilize automatic loader programs that accomplish the same. This is because the user may be rated based on whether the user's intelligent life state is aligned with the user's behavior whenever applicable. It is important to note that it is only likely that a user's behavior deviates from the user's intelligent life state or life/VR view information if the user manually sets, loads, or otherwise defines inaccurate values. If a partner determines that the user's intelligent life state or life/VR view is not accurate, the partner may notify the user of the inaccuracy issue, through a system of ratings. If the user's behavior remains non-aligned with the user's intelligent life state or life/VR view for an extended period of time, the user's rating may continue to decline and/or the information provided to the user may be limited. Following are some conceptual examples of the ratings for a user:
None—The user's transactions are not aligned with the user's intelligent life state or intelligent life view
Low—The user's transactions are minimally aligned with the user's intelligent life state or intelligent life view
Moderate—The user's transactions are mostly aligned with the user's intelligent life state or intelligent life view
High—The user's transactions are significantly aligned with the user's intelligent life state or intelligent life view

The life/VR view information exchange optimization application 497 and 497-1 may be configured to improve information relevance, accuracy, timing, positioning, or other aspects that align the information with a user's actual or predictive behavior. Various methods may be used such as algorithmic, artificial intelligence, learning, statistical analysis, configuration based, or other means that may improve these informational qualities. For example, an application may analyze a user's sport entertainment viewing patterns, history, or purchases, and may use artificial intelligence methods to improve the user's information intelligent life state or intelligent life/VR view information. It is important to note that a user's intelligent life state or intelligent life/VR view information may be set, updated, or altered using a variety of methods; the life/VR view information exchange optimization application 497 and 497-1 may perform additional processing, computations, informational algorithms, learning, or other methodologies as continual improvement to ensure the user's intelligent life state or intelligent life/VR view has an optimal level of information relevance, accuracy, timing, positioning, or other attributes that may make the difference between the user's actual or predictive behavior and the user's information minimal. The users or intelligent partners may initiate or enable configurations that change the way this application may function.

The life/VR view archival application 498 and 498-1 may be configured to allow the archiving of life/VR views, intelligent partner, or user information. Archiving may occur for specific portions of the life/VR view, intelligent partner, or user information, or as a comprehensive function that includes all parts of the life/VR views, intelligent partner, or user information. Archiving may be complete, incremental, or net change based. Archiving may use various methods of security, where accessing the information is limited to only parties that have the rights or privileges to access the information. The life/VR view archival application 498 and 498-1 may use various privacy or security methods that protect the information, such as encryption or Advanced Encryption Standard (AES), application or system activity masking, IP or location masking, or other forms of security and privacy. The life/VR view archival application 498 and 498-1 may also include methods of recovery or reinstating information from archived information. The life/VR view archival application 498 and 498-1 may also allow purges of entire sets of information. The application may also allow users or intelligent partners to manage privileges through the archives. For example, a user may initiate an archive process which includes an intelligent partner's privileged or confidential information, and the intelligent partner may not consent to the archive process; the user may receive a notification to remove that information or the intelligent partner's information may be removed from the archive. It is important to note that archives or recovery of archives may be initiated or managed by users, intelligent partners, an automated system function, artificial intelligence, learning, predictive behavior, or other methods.

The intelligent life/VR views of all of the users may be securely stored in a system associated with the intelligent life/VR view application 490 and in a structure with tables and fields arranged in ways that may be logical or meaningful to a user or partner. When the users may update their intelligent life/VR view, the updated values may be stored in the same system. It is possible that the updates may also be propagated to other replicated systems, devices, appliances that store the values, as well as partners that customize their web sites or resources according to these values. This propagation may be similar to a change trigger.

For some embodiments, a copy of the user's intelligent life/VR view may be downloaded or stored in the memory of a client computing system that may be associated with the user. The copy in the client computing system may be referred to as a local copy of the intelligent life/VR view. It is possible that, in some embodiments, only a portion of the information or only related information may be stored in the client computing system. This is because getting an exact copy may be too big or not technically efficient. Sometimes it might be just the user id that may be stored in floating variables, memory, cache, etc., which then accesses the user's intelligent life view when needed.

The local copy may be periodically updated or synchronized with the values stored in the database. The local copy of an intelligent life/VR view may enable the user to use it with other services, with third parties who are not yet partners, etc. For example, the local copy of the intelligent life/VR view may be used when the user utilizes a mobile phone application for a sport event. For example, when Ticketmaster becomes a partner, it may benefit from accessing the user's attribute values to deliver relevant event search results. It may be noted that the storing of the local copy of the intelligent life/VR view in a client computing system may be different from the intelligent partners or third parties having access to the intelligent life/VR view and information that is filtered through an intelligent life state. As a variation of the application of the intelligent life/VR view, an intelligent partner or third party may access a copy of the intelligent life/VR view from the intelligent life/VR view system (instead of from the client computing system) and customize its mobile phone application according to the user's intelligent life/VR view. Similarly, a search engine may access a copy of the intelligent life state from the intelligent life/VR view system and customize its search results accordingly.

Embodiments of the invention may enable the intelligent life/VR view to be used with an intelligent life state or in a more global information exchange with every conduit that the user may use for information as opposed to strictly web searches or informational resources. For example, when the user visits a website, the user may have the option of selecting to integrate website activity into the intelligent life/VR view or intelligent life state. The option may be a toggle that can be turned on or off, and the information integrated into the intelligent life/VR view, or the website may toggle along with this option. If the website maintains user accounts or information, the user may connect their user id for the website or resource with the intelligent life state or intelligent life/VR view. This may allow greater flexibility and efficiency when the user visits or interacts with a website, or the website is customized for the user.

### Intelligent Information Marketplace

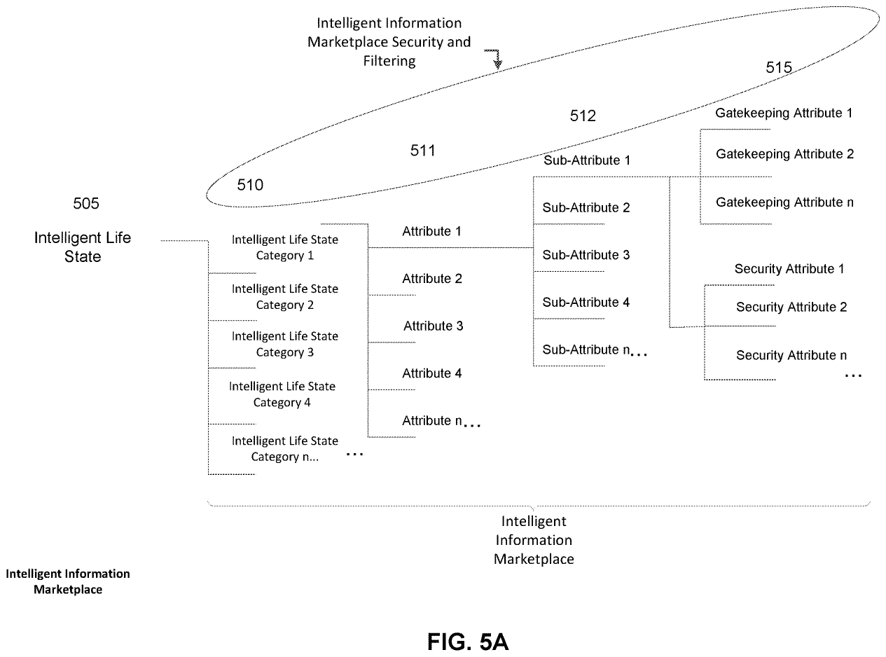

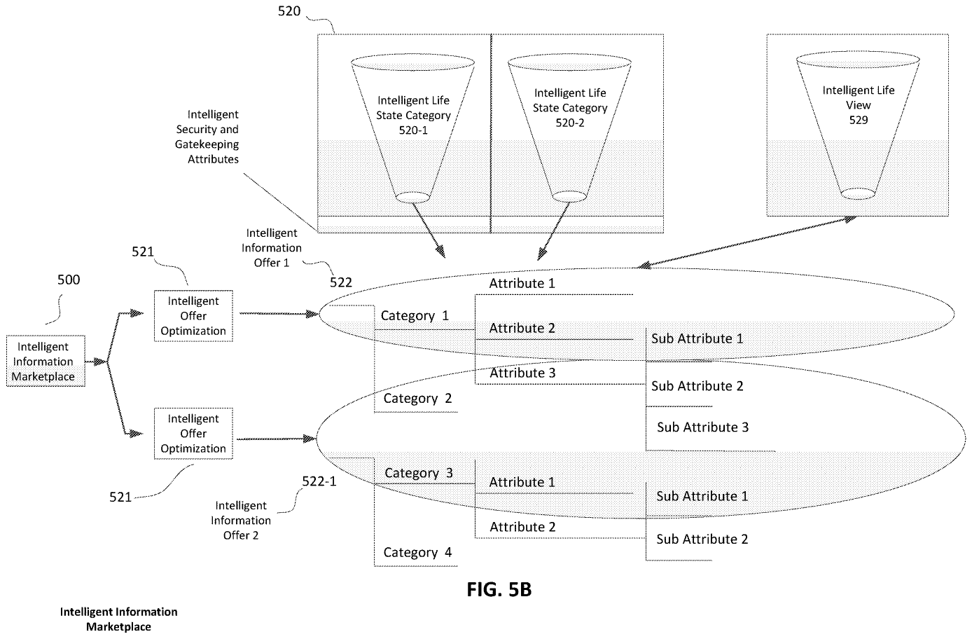

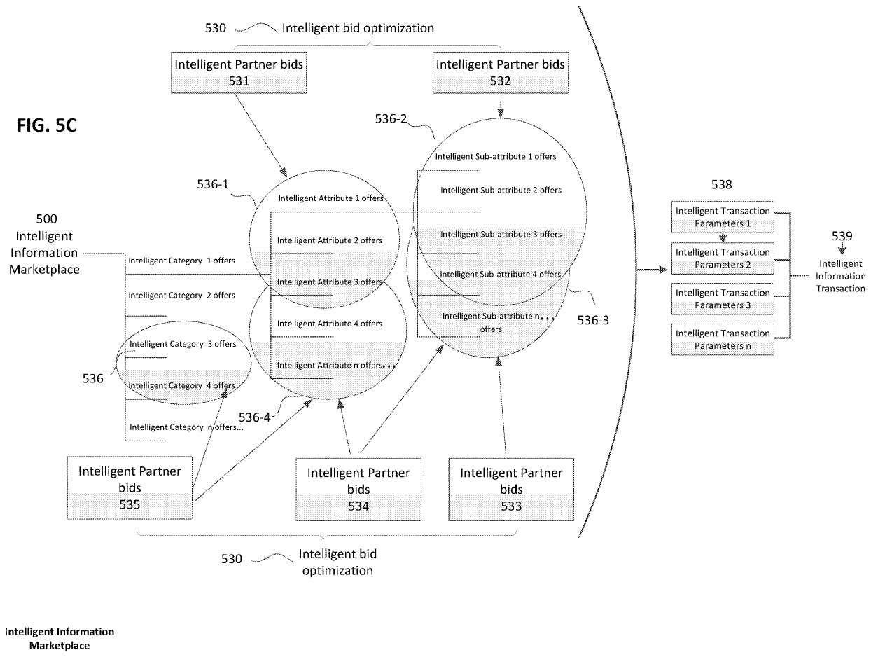

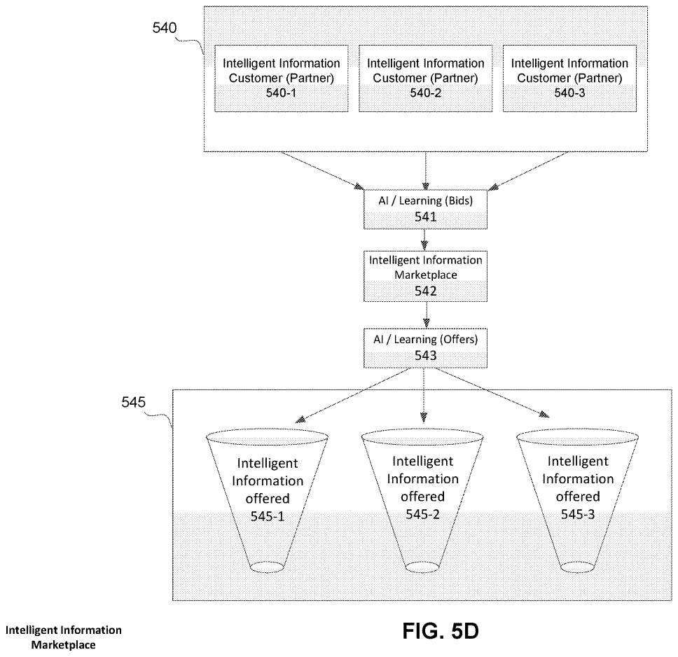

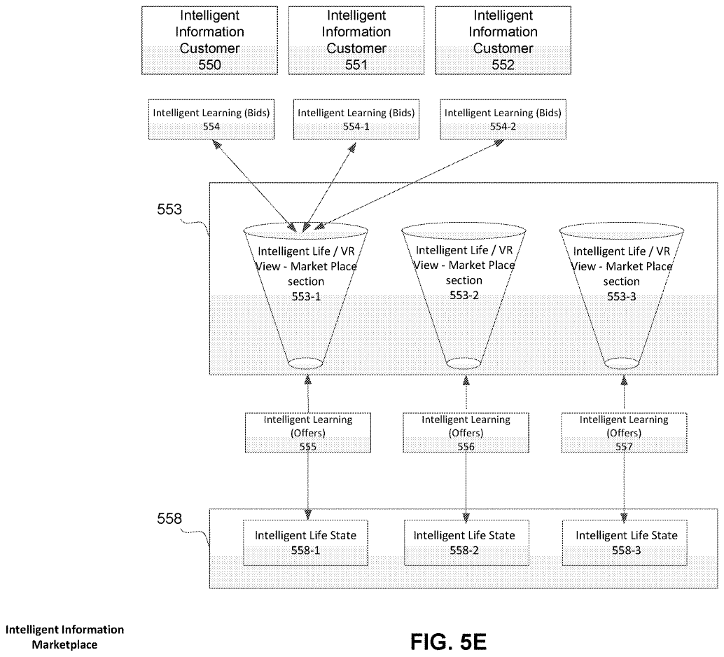

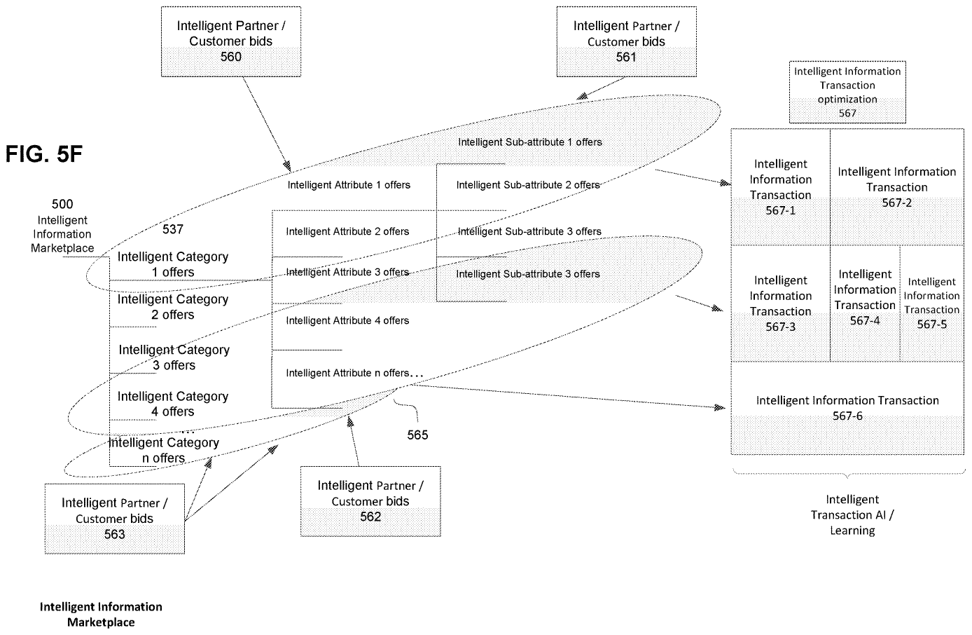

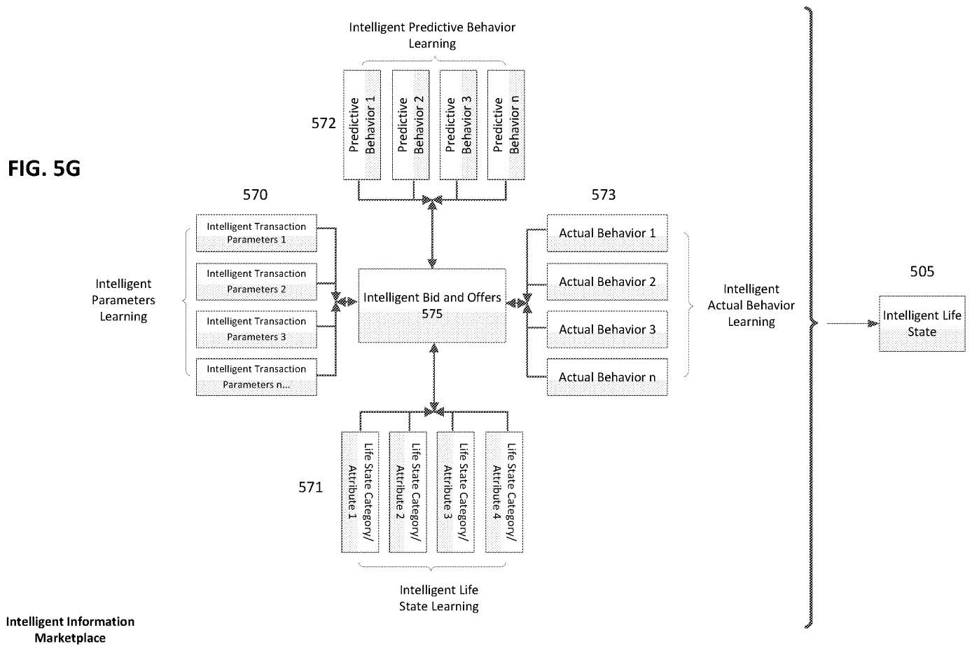

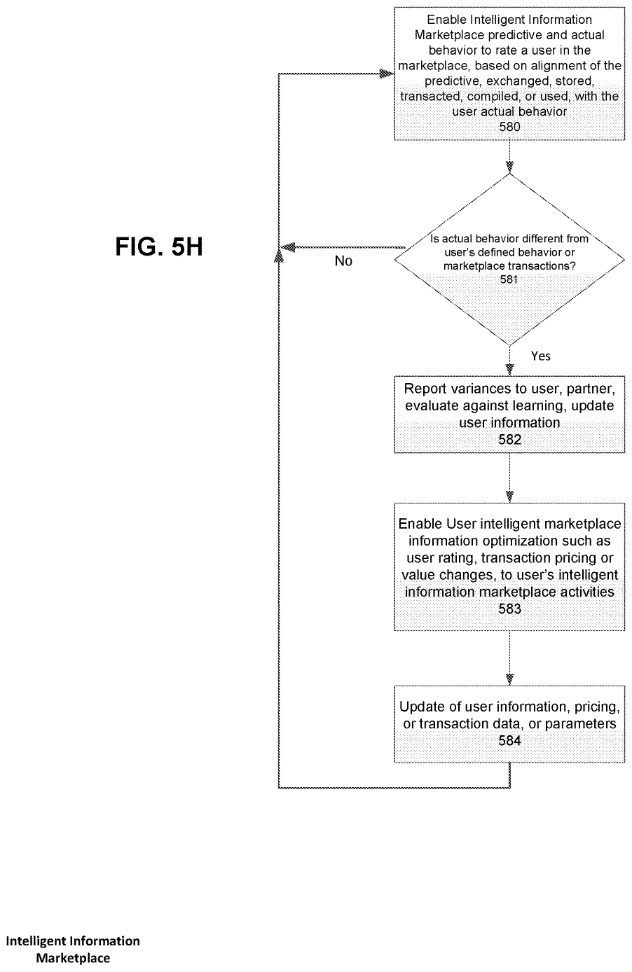

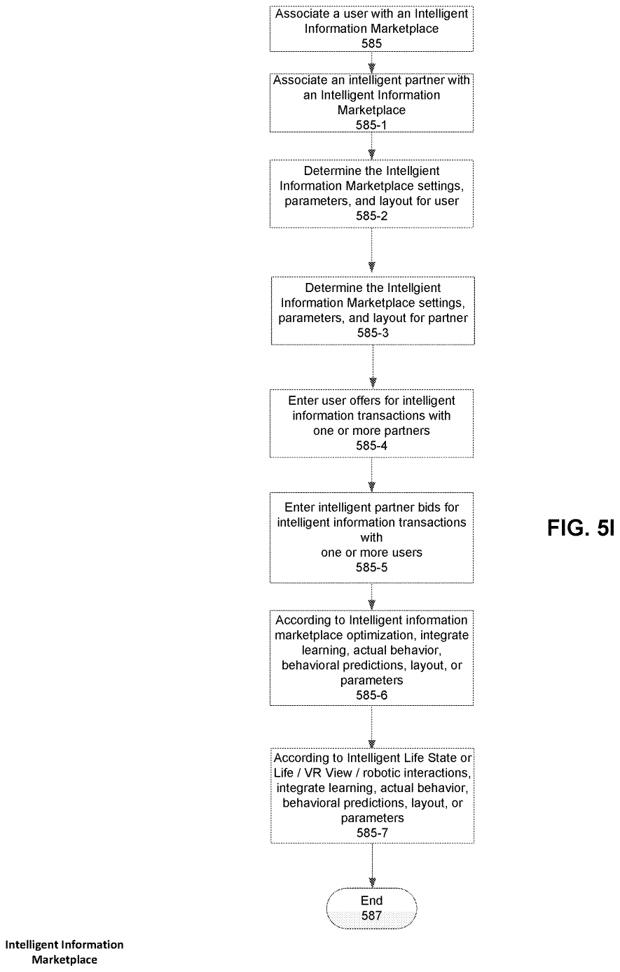

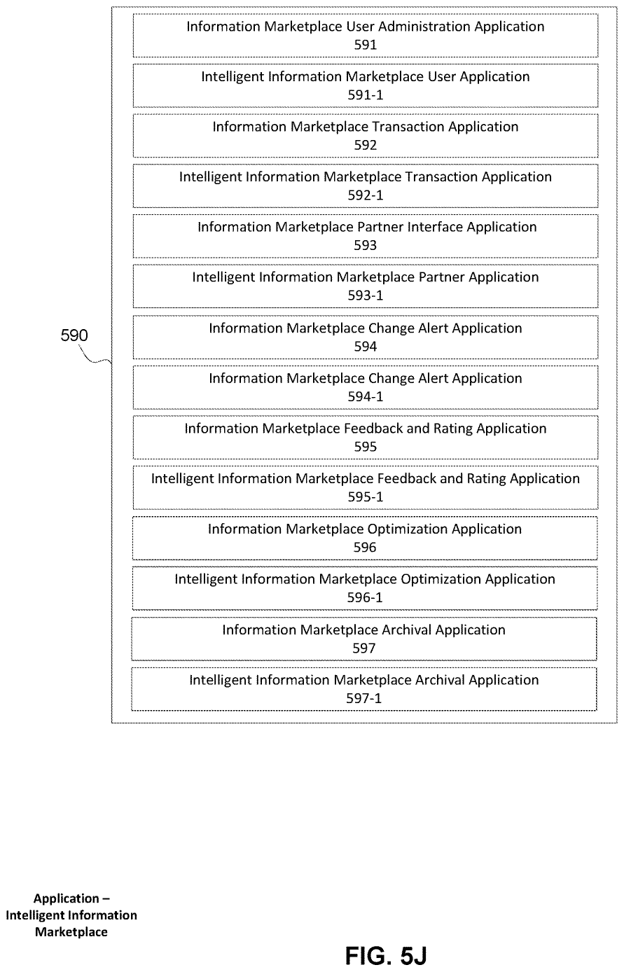

FIG. 5A illustrates an example diagram of information filtering and security, in accordance with some embodiments. The intelligent life state 505 may contain information about a user, including categories, attributes, and sub-attributes. As depicted in 510, many categories may contain information about a user's life. Categories may contain attributes that contain information about a user's life, as depicted in 511. Attributes may contain sub-attributes that contain information about a user's life, as depicted in 512. It is important to note that there may or may not be a relationship between categories, attributes, or sub-attributes. It is also important to note that there may be an extremely large number of categories, attributes, or sub-attributes. As depicted in 515, security or gatekeeping attributes may determine how information is shared or transacted. For example, security attributes may determine whether a user's information may be shared, accessed, transacted, exchanged, or otherwise used in the intelligent life state or intelligent information marketplace. For another example, gatekeeping attributes may determine how information may be shared, accessed, transacted, exchanged, or otherwise used with specific partners, according to specified criteria, such as a timeframe. The information, categories, attributes, or sub-attributes may also be stored as floating variable, cache, memory, etc. on any device or system, which may transaction the information. The intelligent information marketplace may utilize artificial intelligence to determine the most optimal information to transact in the intelligent information marketplace.

FIG. 5B illustrates an example diagram of a view of an intelligent offer and optimization, in accordance with some embodiments. As depicted in 500, an intelligent information marketplace may optimize user information for transacting. It is important to note that there may be many different types of transactions, which may include a sale, purchase, exchange, non-monetary, promotional exchanges, auction, and other transaction types. As depicted in 520, the user information that may be transacted may be categorized by using an intelligent life state category; there may be different categories that are used during an intelligent information offer. For example, intelligent life state category 520-1 may be used as a basis for corresponding attributes or sub-attributes that are used in an intelligent offer. In another example, intelligent life state category 520-2 may be used as another intelligent life state category that may be used as a basis for corresponding attributes or sub-attributes that are used in an intelligent offer. Intelligent offers may include any number of categories, attributes, or sub-attribute values. As noted under 520, information that may be used in an intelligent offer may be controlled or limited according to security or gatekeeping attributes. It is important to note that the use of categories is not required in order to create an intelligent offer. For example, a collection of sub-attributes that may not be connected to an attribute or category may be used in an intelligent offer. As depicted in 521, the direction of the arrows indicates intelligent information offers optimization that may include artificial intelligence, learning, behavioral analysis, or other transactional analysis. Information offer optimization may include a user's intelligent life state, a user's optimized life state information, intelligent information marketplace transactions or activities, or other data analytics. For example, through artificial intelligence analysis, intelligent offer parameters may be changed or recommended; which may include changes in offer price, transaction parameters, or other parts of the offer structure. As depicted in 522, offer collections of categories, attributes, or sub-attributes may comprise an intelligent offer. As depicted in 522-1, offer collections of intelligent life state categories, attributes, or sub-attributes may include multiple intelligent life state categories. As depicted in 529, an intelligent life view may interact with intelligent offers and transactions. For example, an intelligent life view may include intelligent offer information, which may include offer information, parameters, or status.

FIG. 5C illustrates an example diagram of a view of an intelligent bid and optimization, in accordance with some embodiments. As depicted in 500, an intelligent information marketplace may contain various intelligent offers, which may be based on intelligent categories, attributes, or sub-attributes. It is important to note that security or gatekeeping attributes may have already been applied to offers, so those elements are not illustrated here. As depicted in 530, the brackets may indicate intelligent information bid optimization that may include artificial intelligence, learning, behavioral analysis, or other transactional analysis. Information bid optimization may include a user's intelligent life state, a user's optimized life state information, partner transactions, partner attributes or settings, intelligent information marketplace transactions or activities, or other data analytics. For example, through artificial intelligence analysis, intelligent bid parameters may be changed or recommended; which may include changes in bid price, transaction parameters, or other parts of the offer structure. It is important to note that there may be many different types of transactions, which may include a sale, purchase, exchange, non-monetary, promotional exchanges, auction, and other transaction types. As depicted in 531, an intelligent partner bid may include one or more intelligent attributes, as depicted by 536-1. For example, as depicted in 536-1, intelligent attribute offers 1, 2, and 3 may be included as a collection of intelligent offers for which the intelligent partner bid 531 may respond to. As depicted in 532, an intelligent partner bid may include one or more intelligent sub-attributes, as depicted by 536-2. For example, as depicted in 536-2, intelligent sub-attribute offers 1, 2, 3, and 4 may be included as a collection of intelligent offers for which the intelligent partner bid 532 may respond to. As depicted in 533, an intelligent partner bid may include one or more intelligent sub-attributes that may also include new sub-attributes that may be created, as depicted by 536-3. For example, as depicted in 536-3, intelligent sub-attribute offers 3, 4, and future sub-attributes n may be included as a collection of intelligent offers for which the intelligent partner bid 533 may respond to. As depicted in 534, an intelligent partner bid may include one or more intelligent attributes and sub-attributes that may also include new attributes and sub-attributes that may be created, as depicted by 536-3 and 536-4. For example, as depicted in 536-3 and 536-4, intelligent attribute offers 3, 4, and future attributes n, and sub-attribute offers 3, 4, and future sub-attributes n may be included as a collection of intelligent offers for which the intelligent partner bid 534 may respond to. As depicted in 535, an intelligent partner bid may include one or more intelligent categories and attributes that may also include new attributes that may be created, as depicted by 536 and 536-4. For example, as depicted in 536 and 536-4, intelligent category offers 3, 4, and intelligent attribute offers 3, 4, and future sub-attributes n may be included as a collection of intelligent offers for which the intelligent partner bid 535 may respond to. It is important to note that any combination of intelligent categories, attributes, or sub-attributes may be used in an offer or a bid; and any type of parameters for categories, attributes, or sub-attributes may be used in an offer. It is important to note that an intelligent partner may use bids that are not in response to an offer. For example, an intelligent partner may create bids for intelligent category, attribute, or sub-attribute information without an existing offer; this may be done to communicate potential intelligent offers that users may consider. As depicted in 538, intelligent transaction parameters may be used as an agreement is made for an intelligent offer and bid. For example, an intelligent offer may be modified as a result of the intelligent offer and bid process, which may include recommendations made by artificial intelligence or learning that may result in an agreeable transaction. Intelligent transaction parameters may include any type of parameter that may be applied to an intelligent offer or bid. For example, an intelligent parameter may be used that specifies that, in addition to the intelligent partner receiving the information, the intelligent partner may receive updates to the information for a year. As depicted in 539, an intelligent offer that has an accepted an intelligent bid, may result in a transaction that specifies terms typical in an informational transaction. For example, the transaction may include the category, attribute, or sub-attribute definitions and values, transaction date, transaction price, transaction terms, transaction duration, and so on.

FIG. 5D illustrates an example diagram of an intelligent information transaction. As depicted in 540, there may be intelligent information customers or partners. As depicted in 540-1, 540-2, and 540-3, there may be multiple intelligent information customers or partners. Intelligent information customers may submit bids in response to intelligent offers, as depicted in 545. It is important to note that intelligent information customers may also submit intelligent bids that are offers to buy intelligent information, without an intelligent offer in existence; and in this case, an intelligent offer may be submitted in response. It is also important to note that a buyer or seller of information may simply accept an offer or bid without further analysis, negotiation, or activity. As depicted in 541, artificial intelligence or learning may be used to interact with or optimize intelligent bids. For example, an intelligent recommendation may specify to an intelligent customer or partner that their bid price may be too high or low for the information offered, when compared to behaviors or transaction patterns of buyers or sellers. As depicted in 542, intelligent bids may be managed or effectuated in an intelligent information marketplace. As depicted in 543, intelligent offers may be submitted, which may be managed or effectuated in an intelligent information marketplace 542. For example, an intelligent recommendation may specify to a user that their offer terms may be too long or short for the information offered, when compared to behaviors or transaction patterns of buyers or sellers. As depicted in 545, multiple offers may be submitted. As depicted in 545-1, 545-2, 545-3, multiple intelligent offers may be optimized by 543 and submitted to an information marketplace 542. It is important to note that an extremely large number of intelligent bids, offers, information buyers, information sellers, or optimization may be used.

FIG. 5E illustrates an example diagram of intelligent information marketplace transactions integrating with an intelligent life/VR view and intelligent life state. As depicted in 550, 551, and 552, multiple intelligent information customers or partners may submit bids 554, 554-1, and 554-2. As depicted in 553, there may be multiple intelligent life/VR views 553-1, 553-2, and 553-3. Multiple intelligent life bids may be integrated with the intelligent information marketplaces 553. For example, multiple intelligent partners or customers may have multiple intelligent bids for user entertainment information that may integrate with an intelligent life/VR view 553-1. As depicted in 555, 556, and 557, intelligent offers may use information from an intelligent life state and may be integrated into an intelligent life/VR view of a user's information 553. As depicted in 558, there may be multiple intelligent life states 558-1, 558-2, and 558-3. For example, a user may offer to sell their sporting event attendance information, which may be stored in their intelligent life state. The intelligent offer for sporting event attendance may be included in the user's intelligent life/VR view; and there may be multiple intelligent partner or customer bids to purchase the user's sporting event attendance information. It is important to note that there may be an extremely large number of users, intelligent partners or customers, intelligent offers, intelligent bids, parameters, settings, and transactions.

FIG. 5F illustrates an example diagram for intelligent transaction optimization, with some embodiments. As depicted, an intelligent information market 500 may offer user information for sale. Intelligent categories 537 may be used for determining intelligent categories, attributes, or sub-attributes to sell. As depicted in 560, 561, 562, and 563, intelligent partner bids may be submitted by multiple partners for various collections of intelligent category, attribute, or sub-attribute information. As depicted in 567, information marketplace transactions may be used as inputs, parameters, or models that optimize present or future information marketplace transactions. As depicted in 567-1, 567-2, 567-3, 567-4, 567-5, or 567-6, different depictions of marketplace transactions may be used to perform optimization. Transaction information such as the buyer, seller, quantity, durations, price, terms, or other parameters or settings, may be used in optimization. Optimization may use forms of artificial intelligence, learning, actual behavioral modeling, predictive behavioral modeling, or other forms of algorithmic calculations that may provide meaningful analysis, recommendations, or output. For example, an intelligent offer for sporting event attendance information may use transaction optimization that determines to what extent the sporting event attendance may predict future behavior; and this may also allow a higher price to be charged for the information. Using this same example, if the intelligent information offer has a high likelihood of predicting future behavior, an intelligent partner may choose to pay a higher price or specify an exclusive right to the information. It is important to note that an extremely large number of intelligent information transactions, bids, offers, users, partners, parameters, or other inputs may be used in optimization.

FIG. 5G illustrates an example diagram for intelligent transaction learning that may be integrated into an intelligent life state, with some embodiments. As depicted in 570, intelligent transaction parameters may be used to determine intelligent life state information accuracy. For example, a transaction parameter that provides six months of the user's professional sporting events watched, at a low price, may indicate that the user information is more likely to change; and the intelligent life state may be updated to more accurately predict what sporting events the user may watch. As depicted in 571, intelligent life state category or attribute values may be used to improve intelligent life state information accuracy. For example, the user may have an intelligent life state attribute value that indicates their favorite sporting event, and team is football and the Los Angeles Rams, respectively; and the intelligent marketplace has much more transaction activity for the Los Angeles Lakers, which may indicate that the user's favorite sport and team is the Los Angeles Lakers. It is important to note that the intelligent life state may have many sources of manually or automatically updating category, attribute, or sub-attribute values, and the intelligent marketplace is another source that may allow intelligent life state category, attribute, or sub-attribute information to be brought up to date. As depicted in 572, predictive behavior may be used to improve intelligent life state information accuracy. For example, if many intelligent information marketplace transactions are optimized in a way that user information has a high likelihood of predicting behavior, that information may be integrated into the user's intelligent life state. For another example, if a user's intelligent marketplace optimization indicates that their favorite sport to watch will change from football to basketball, this information may be integrated into the user's intelligent life state. As depicted in 573, actual behavior may be used to improve intelligent life state information accuracy. For example, if a user's intelligent offers and bids are greater in number for actual behavior that is aligned with watching thriller movies, than for other genres, then the user's intelligent life state may be updated to reflect thriller movies as a preferred genre. As depicted by the direction of the arrows, the intelligent life state 505 may be updated with the learning, optimization, or alteration of the intelligent marketplace bids, offers, or transactions in general. It is important to note that some of the analysis done may include information from both the intelligent life state and the intelligent information marketplace.

FIG. 5H illustrates example applications that may be used to rate users, which may be according to behavioral alignment, in accordance with some embodiments. As depicted in 580, a user's predictive and actual behavior may be compared or contrasted. It is important to note that many types of information may be used, such as manually defined or derived categories, attributes, or sub-attributes, as well as automatic loader programs or data capture from devices, or forms of artificial intelligence. For example, over time, a user's intelligent life state categories, attributes, or sub-attributes may deviate from the values that may be transacted, which may show a delta between actual and predictive values. As depicted in 581, an assessment is made between the actual and predictive values, which may include qualitative terms that describe how accurately or inaccurately the user's actual behavior is aligned with the predictive behavior. It is important to note that there may be many forms of comparison or contrasting user behavior, and there may be many types of inputs and outputs in determining a user's predictive or actual behavior. As depicted in 582, variances may be reported to the user or partner, or the user information, bids, or offers may be updated. For example, if a user's intelligent life state indicates that their top travel destinations are US states in the southeast, yet most intelligent marketplace transactions involve information that may indicate the user's top travel destinations are the US states on the west coast, then the user or partners may be alerted to this discrepancy, and the user's intelligent life state values may be updated. It is important to note that security, gatekeeping attributes, or transaction terms may limit information that is sent to a partner. As depicted in 583, user or transaction information, parameters, or other data points in the intelligent information marketplace transactions may be determined according to optimization. As depicted in 584, user or transaction information, parameters, or other data points in the intelligent information marketplace transactions may be automatically updated.

FIG. 5I illustrates example applications that may be used to process, manage, or optimize the intelligent information marketplace. As depicted in 585, a user may be associated with an intelligent information marketplace. It should be noted that there may be an extremely large number of users for an information marketplace. As depicted in 585-1, a partner may be associated with an intelligent information marketplace. It should be noted that there may be an extremely large number of intelligent partners for an information marketplace. As depicted in 585-2, intelligent information marketplace settings, parameters, or layouts for a user may be defined. As depicted in 585-3, intelligent information marketplace settings, parameters, or layouts for a partner may be defined. It is important to note that the number of settings, parameters, or layouts for users or partners may be extremely large. As depicted in 585-4, user offers may be entered for intelligent information transactions with one or more partners. As depicted in 585-5, intelligent partner bids may be entered for intelligent information transactions with one or more users. As depicted in 585-6, according to intelligent information marketplace optimization, learning, actual behavior, behavioral predictions, layout, or parameters may be integrated into the transaction. As depicted in 585-7, according to intelligent life state or life/VR view interactions, learning or artificial intelligence, actual behavior, behavioral predictions, layout, or parameters may be integrated.

FIG. 5J illustrates example applications that may be used to enable or manage an intelligent information marketplace, in accordance with some embodiments. The intelligent information marketplace 590 may include an information marketplace user administration application 591, information marketplace transaction application 592, information marketplace partner interface application 593, information marketplace change alert application 594, information marketplace feedback and rating application 595, information marketplace optimization application 596, and information marketplace archival application 597. Each application may have an intelligent component, which may utilize artificial intelligence, learned behavior, actual behavior, predictive behavior, or other various methods to optimize or alter the application settings. These applications for the information delivery system 590 may include intelligent information marketplace user administration application 591-1, intelligent information marketplace transaction application 592-1, intelligent information marketplace partner interface application 593-1, intelligent information marketplace change alert application 594-1, intelligent information marketplace feedback and rating application 595-1, intelligent information marketplace optimization application 596-1, and information marketplace archival application 597-1.

It may be noted that even though these applications are described herein as separate applications, the functionalities of two or more of them may be combined into one application. These applications may be used to manage transacted or exchanged information from or to various resources. The resources may include partners, users, buyers, sellers, or other trading parties that may exchange, grant, or acquire information. Non-Internet or non-digital resources may also be used. For example, a user's intelligent offer or a partner's bid may be replicated or displayed on devices, appliances, or any means that allows the user or partner to control how to transact information, grant permission to the user's intelligent life state information, or to exchange user information with intelligent partners. It may be noted that not every device or appliance used in embodiments of the invention is an information transaction mechanism. That is, some devices may be registered in the core system to receive or manage information, where other devices may only function in the ecosystem as a conduit for the transacting of filtered information among the intelligent partners or users.

The user administration applications 591 or 591-1 may be configured to manage the users and the partners, which may include setting up their user accounts, user IDs, passwords, etc. These user accounts may allow the users to participate in the intelligent information marketplace system 590. The user accounts may be stored in the database associated with the intelligent information marketplace system 590. The user accounts of the users may be encrypted or stored locally in the client computing systems. The client computing systems may be appliances, devices, etc. This may enable a partner to recognize a user as a member of the intelligent information marketplace system, intelligent life/VR view system, or intelligent life state system when the user visits a website or resource associated with a user or partner. This may enable the partner to keep track of the user's behavior while visiting that website or resource to determine if the user's behavior is aligned with the user's intelligent life state or intelligent information marketplace transactions. The user administration applications 591 or 591-1 may also keep track of user type (e.g., user, administrator, etc.), partner type (e.g., individual, organization, etc.), partner category (e.g., content provider, advertiser, etc.), partner status (e.g., active, revoked, suspended, pending, etc.), the type of license granted to the partner, etc. It may be noted that the user may be an individual, an organization, a business, etc.

The intelligent information marketplace transaction application 592 or 592-1 may be configured to perform operations associated with processing information offers, bids, or transactions of many users or partners. The intelligent information marketplace transaction application 592 or 592-1 may be configured to enable an administrator to define an intelligent information marketplace transaction structure including the use of categories, attributes, sub-attributes, layout parameters, or other settings. The intelligent information marketplace transaction application 592 or 592-1 may be configured to present or display a bid, offer, or transaction interface to allow the users and partners to transact information, which may also integrate the updating of the values for the attributes and sub-attributes for user intelligent life states; or also the integration with a user's intelligent life/VR view.

The intelligent information marketplace transaction application 592 or 592-1 may be configured to allow the users or intelligent partners to define how the information is transacted between a user and partner. The intelligent information marketplace transaction application 592 or 592-1 may be configured to provide a layout interface to allow the user or intelligent partner to design the look and feel of information transactions. The layout interface may include parameters to control the fields, links, dimensions, or positioning of the information. The user or intelligent partner may define multiple configurations that change according to event rules defined by a user or intelligent partner. For example, the user may define parameters that cause the layout to emphasize accepted offers when there are new offers that were accepted. The intelligent information marketplace transaction application 592 or 592-1 may be configured using threshold settings that suggest various pricing or other transaction parameters. For example, the user may define threshold settings to filter only information that may be sold at a certain price level. It is important to note that there may be any number of different settings of layout or pricing parameters. The layout interface may allow a user or intelligent partner to define different durations or types of information that may be transacted. Each of the information durations may specify how long a partner receives real-time updates on information categories, attributes, or sub-attributes sold. As mentioned, users or partners may define price thresholds, such as price ranges on the intelligent offer or bid. It is important to note that there may be an extremely large amount of transaction parameters, settings, or alterations. The system configurations, layouts, or thresholds may be stored in a system associated with an intelligent information marketplace transaction system 590.

For some embodiments, the intelligent information marketplace transaction application 592 or 592-1 may also be configured to perform consistency verification to determine if user actual behavior is reflected in the user's intelligent information marketplace transactions, intelligent life state, or the respective application settings, parameters, security, or gatekeeping.

The intelligent information marketplace partner interface application 593 or 593-1 may be configured to enable the intelligent information marketplace system to communicate with one or more systems of the partners. For example, this may enable the partners to access the users' intelligent information marketplace offers, which may include users' transaction parameters, pricing, or other settings. This may include interfacing with the partners to enable customized resources, filtered lists, reporting, etc.

The intelligent information marketplace change alert application 594 and 594-1 may be configured to notify the partners and the users whenever there is a change that may affect the intelligent information marketplace, intelligent life state, intelligent life/VR view, or intelligent information marketplace transaction information. The changes may originate from the partners'and/or users' transaction activities. For example, the change may include a user intelligent offer that is accepted by a partner. In another example, the change may be a user's actual behavior deviating from their intelligent information marketplace transactions or the user's intelligent life state. The changes may originate from automation, artificial intelligence, actual behavior, planned behavior, predictive behavior, transactional triggers, internally by a management team, user settings, partner settings, or by other means. The changes may involve any types of structure, data definitions, values, or system attributes. For example, it may be necessary to add a new category, to move an attribute from one category to another category, to delete an attribute, to change the meaning of a sub-attribute, etc., which may affect intelligent information marketplace transactions. The changes may also originate externally by other parties. The change alert application 594 and 594-1 may also be configured to notify a partner when a user's life state is modified. Similarly, the change alert application 594 and 594-1 may notify a user when a partner's bid is modified or updated.

The intelligent information marketplace feedback and rating application 595 and 595-1 may be configured to improve the quality, relevance, or accuracy of the information transacted. This may include providing a mechanism to allow users or partners to provide feedback regarding the marketplace transactions or the accuracy of the user's intelligent life state, intelligent life/VR view, or the partners' accuracy of interacting with users based on the information they may have procured. This may include providing a mechanism to allow the users to rate the partners, as well as a mechanism to allow the partners to rate the users. The rating of the partners may be based on whether the information transacted by the partners is aligned with the partners' interactions, information delivered, or customized resources for the user. The rating may also be based on a collection of feedbacks from many users. This may help the partners to fine tune their user customization methodologies if they receive low ratings. This also may help identifying the partners who consistently struggle to improve their information accuracy, relevance, or timeliness. For example, a partner who provides inaccurate advertising information that is different from the information they transacted may get a low rating because it may not be relevant to the user's actual behavior. A consequence for a partner who gets a low rating may be a suspension or revocation of its license or ability to transact information for a user or for users. Following are some conceptual examples of the ratings for a partner:
None—The information from the partner may not be aligned with the user's intelligent life state, intelligent life view, or information transacted by the partner
Low—The information from the partner may not be minimally aligned with the user's intelligent life state, intelligent life view, or information transacted by the partner
Moderate—The information from the partner may be mostly aligned with the user's intelligent life state, intelligent life view, or information transacted by the partner
High—The information from the partner may be significantly aligned with the user's intelligent life state, intelligent life view, or information transacted by the partner

In order for a user to successfully transact their information, it may be necessary for the user to keep the user's intelligent life state or intelligent life/VR view updated by utilizing artificial intelligence, learning, or other methods, or to utilize automatic loader programs that accomplish the same. This is because the user may be rated based on whether the user's intelligent life state is aligned with the user's behavior or the user's transacted information whenever applicable. If a partner determines that the user's intelligent life state or life/VR view is not accurate when compared to information transacted or the user's actual behavior, the partner may notify the user of the inaccuracy issue, through a system of ratings. If the user's behavior remains non-aligned with the information transacted or sold by the user, the user's intelligent life state or life/VR view for an extended period of time, the user's rating may continue to decline and/or the user's ability to transact their information may be limited. Following are some conceptual examples of the ratings for a user:
None—The user's transactions are not aligned with the user's transacted information, the intelligent life state, or the intelligent life view
Low—The user's transactions are minimally aligned with the user's transacted information, the intelligent life state, or the intelligent life view
Moderate—The user's transactions are mostly aligned with the user's transacted information, the intelligent life state, or the intelligent life view
High—The user's transactions are significantly aligned with the user's transacted information, the intelligent life state, or the intelligent life view

The intelligent information marketplace optimization application 596 and 596-1 may be configured to improve information or transaction relevance, accuracy, timing, pricing, or other aspects that align actual behavior with a user's information that is offered for sale. Various methods may be used such as algorithmic, artificial intelligence, learning, statistical analysis, configuration based, or other means that may improve these informational or alignment qualities. For example, an application may analyze a user's sport entertainment viewing patterns, history, or purchases, and may use artificial intelligence methods to improve the user's transaction value for selling their information. It is important to note that a user's intelligent life state or intelligent life/VR view information may be set, updated, or altered using a variety of methods; the intelligent information marketplace optimization application 596 and 596-1 may perform additional processing, computations, informational algorithms, learning, or other methodologies as continual improvement to ensure the user's intelligent offers and the partners intelligent bids have a level of information relevance, accuracy, timing, alignment, or other attributes that may make the difference between the predictive behavior and the user's information offered for sale minimal. The users or intelligent partners may initiate or enable configurations that change the way this application may function.

The intelligent information marketplace archival application 597 and 597-1 may be configured to allow the archiving of intelligent information marketplace operations and activities, intelligent partner, or user information. Archiving may occur for specific portions of the intelligent information marketplace operations and activities, intelligent partner, or user information, or as a comprehensive function that includes all parts of intelligent information marketplace operations and activities, intelligent partner, or user information. Archiving may be complete, incremental, or net-change based. Archiving may use various methods of security, where accessing the information is limited to only parties that have the rights or privileges to access the information. The intelligent information marketplace archival application 597 and 597-1 may use various privacy or security methods that protect the information, such as encryption or Advanced Encryption Standard (AES), application or system activity masking, IP or location masking, or other forms of security and privacy. The intelligent information marketplace archival application 597 and 597-1 may also include methods of recovery or reinstating information from archived information. The intelligent information marketplace archival application 597 and 597-1 may also allow purges of entire sets of information. The application may also allow users or intelligent partners to manage privileges through the archives. For example, a user may initiate an archive process which includes an intelligent partner's privileged or confidential information, and the intelligent partner may not consent to the archive process; the user may receive a notification to remove that information or the intelligent partner's information may be removed from the archive. It is important to note that archives or recovery of archives may be initiated or managed by users, intelligent partners, an automated system function, artificial intelligence, learning, predictive behavior, or other methods.

### Exemplary Usage

An example of a typical partner of the information system may be a manufacturer of apparel branded with team logos and similar branded paraphernalia. The manufacturer has experience (i.e., unstructured data) indicating that most fans purchase 2 or 3 hats and shirts that are branded with their favorite team. The manufacturer also has pre-existing knowledge (i.e., unstructured data) that ballparks and stadiums sell branded merchandise at high prices. In this example, the manufacturer has an overstock of hats with team logos and wishes to rapidly sell them. This inventory data is structured. The manufacturer becomes a partner of the information system and authorizes the acquisition of structured and unstructured data streams to rapidly find buyers from the base of users. The information system described herein is loaded with structured and unstructured data for users in zip codes within 50 miles of ballparks and stadiums. A structured calendar of sporting events data is used to match teams playing at each ballpark or stadium location on any given day with the inventory that is branded with those teams' logos. A structured ticketing database is accessed to identify users who were buyers of tickets to the ball parks and stadiums on dates when games were played or are scheduled to be played. A structured credit card database is accessed to identify users who made credit card transactions at any of the ballparks or stadiums on the prior event days. The manufacturer believes that there is a high probability that users who purchased team paraphernalia at the game would purchase more at lower prices. The manufacturer also believes that users are likely to purchase new hats within 30 days of attending a prospective event. Using these various data streams and probabilities, the manufacturer can utilize the information delivery system to intelligently reduce its inventory of branded hats and other merchandise in the shortest time possible. The information system transforms the data into tailored offers that highlight the teams' paraphernalia to users who attended an event and made purchases at the event. The information system also transforms the data into alternative tailored offers for users who attended an event or within 30 days of users' anticipated attendance at an event.

An example of another partner is an email service provider for non-paying users. This free email service provider wishes to capitalize on the information stored in client email messages and related attachments. Using the Microsoft Software Developer Toolkit, PST File Software Developer Kit, the Protection SDK and other commonly available software development tools, the partner is able to transform unstructured email data from a large number of messages into structured data that is sold to third parties. The primary email data file formats are OST (Offline Storage Table) and PST (Personal Storage Table), however other formats may be used.

The third parties include travel agents, theme parks, manufacturers and service providers. The transformed data has been intelligently analyzed to identify users who are more likely to complete a purchase or other transaction. The clients' identity is linked to data indicative of whether the client has a need or desire that the third party can fulfill. The access to this data is typically subject to the privacy and terms of service agreements between the client and service provider. Many such agreements allow the email service providers to read the users' email contents; other email service providers do so without express consent.

As an example, user Jill sends user Jack an email that says, “I feel depressed. I need something to cheer me up.” User Jack replies, “Maybe we should go someplace happy.” The email service provider reads this unstructured exchange and adds these users to a structured data package called Potential Travel Buyers. The bundled user contact information for a multitude of users gleaned from reading the email message contents may be transformed into a high value product. The structured data package has user contact information to allow third parties, such as online travel agents, cruise lines, theme parks, and other organizations, to make an offer of products or services to Jill and Jack. The individual and bundled user identities may be sold, auctioned, traded, or transferred to the third parties. Similar bundles of contact information can be generated from the contents of attachments such as photos. For example, all attached photos that include pictures of a bride or wedding party may be aggregated to create a bundle of user contacts for Newly Wed Gifts and Services.

An example of another similar activity occurs when the cell phone text message repository is accessed by the information delivery system. The text messages, and related attachments, may be read or viewed to identify user information that may be bundled or sold individually to third parties. The access to the text message repository may be ancillary to the access to the cell phone sensors for GPS and other monitored settings.

As another example, enhanced accuracy of users' predicted behaviors may be achieved with the inclusion of information from sensors that indicate values for at least one of location, position, orientation, GPS coordinates, temperature, pressure, weight, environmental light, or radio-frequency signal. The data values for sensor information may be sent through the network and stored in the datasets with relevant user information. These sensor data values may be compared to previously stored sensor values to determine a change, such as GPS coordinates for a user's cell phone in a moving car. Sensor data becomes an attribute of the life state information of users and may be used in both actual and training contexts. User identification, whether through biometrics, facial recognition or cell phone signals, allows the sensor data to be applied to an individual user or group of users.

Embodiments of the invention may also include mobile-enabled implementations to enable the users to use mobile devices to communicate with the information delivery server. As a non-limiting example, the client computing system may include a smart phone coupled with the information delivery server via the network. The mobile capability may enable the users to provide updates for impulsive behavior, especially at a time when the user is experiencing an event that may need to be reflected in the user's life state. The information delivery server may enable the user to download a mobile application for this purpose or it may be available in a commercial aggregation of mobile applications. The mobile application may include a user interface that makes it easier to provide information about the user's experience. The mobile application may include auto-load programs or API's to automatically capture some or all the user's life state and communicate the information to the information delivery server. The mobile application may also allow a user to further modify the information of the life state. For example, the user may be watching a movie, and the user may use the mobile device to indicate the name of the movie and how much the user enjoys watching that movie. That action may then be analyzed by the information delivery server and the user's entertainment attribute may be updated.

Also, a sensor device may obtain information about a user and the user may not be aware of the acquired data. For example, a cell phone with a GPS device may report the location of a user at an exact time. These data values or datasets may be reflected in the user's Life State. Similarly, a commercial building or store may employ sensors that detect the user's cell phone and transmit those data values or datasets to the information delivery systems of third parties. In certain embodiments, the data from sensors may be emulated or approximated and applied as training data to the information delivery system.

In some embodiments, the user travels to places in the real world while also carrying a mobile communication device that has global positioning system (GPS) capabilities to track the user's movements. The client computing system synchronizes the GPS data describing the user's travels to the information delivery server via the network. The information delivery server then updates the user's Life State with the locations visited by the user. Other methods besides GPS may be used to obtain location data. For example, Wi-Fi signals and Bluetooth signals are commonly used to acquire location data.

In yet another embodiment, the user has a virtual reality (VR) headset that comprises sound and three-dimensional vision hardware. The VR headset communicates with the client computing system for most operations but may also be capable of communicating directly to the information delivery server. One commonly available headset is the Oculus VR from Facebook, but others may be used. Most models include sensors and hand-held switches that allow the user to select items viewed in the virtual world while monitoring the user's position and orientation in the real world. The position and orientation information allows a representative avatar in the virtual world to move according to the user's coordinates. The user's life state in the real world is translated into a VR life state with related VR life views. The user's actions in the virtual world may be translated into real world actions or choices, and vice versa. For example, selecting a product in the VR world may be interpreted as the user having selected the same product in the real world. This allows users with physical limitations to more easily simulate real world experiences. Similar to the bundling of email users with common traits, the users with common VR life state traits or categories may have their contact information bundled for sale to appropriate partners with products or services that might be of value to the VR users in either the virtual or real world.

The VR life state of the user includes interfaces with simulated events and characters that may indicate real world preferences. For example, background music choices in VR life are likely to correspond to real world preferences, thereby populating a real world life state category with relevant information. The same is true for other psychological choices such as anger, sadness, and happiness. If something makes the user angry in the real world, a similar thing likely makes the user angry in the virtual world. However, it may be easier to detect these psychological traits in the virtual world because there are fewer constraints on user behavior. This allows the virtual world to be a test environment for user responses and allows for predictions to be made for potential real-world behavior or decision-making. These predictions allow for easier marketing of products and services in the real world through the bundling of predicted user responses to corresponding events, actions, triggers or offers.

The selection of products or services in the virtual world may be reported back to the information delivery server through one or more firewalls where the user life state is updated with this information. The selections made in the virtual world are weighted in comparison to selections made by the user in the real world. This weighting, whether higher or lower, assists in the intelligent predictions for user behavior in both real and virtual environments.

### Marketplace—Exemplary Usage

In an example of the Information Marketplace, a user or collection of users may offer their information for sale. In this example, partners may purchase or bid for access to the information offered by users. For example, Amazon may purchase information about a user's shopping behavior or interests, listings of online or physical organizations that sold products or services to the user, or user consumption habits, or other information that may be in demand. A purchase transaction may include information at any one point in time, or it may also include future information updates for a set duration. In this example, a user may offer to sell to Amazon, all their transaction history for clothing purchases over the last year from various retailers, and the user may also offer to send continual future updates or additions to that information for these clothing purchase transactions for the next year. It is important to note that offers and bids for information may come in any form, such as being monetary, promotional, discounts for the buyers' products or services, early access to the buyers services or products, or other forms of compensation or value. Through learning or various methods of artificial intelligence, optimal or relevant transactional attributes may be suggested, such as the type of information offered or bid amount, price, value, quantity, promotional values, discount values, durations, or other transactional data. Using this example, Amazon may offer to buy the user's clothing purchase information by offering a monetary value, discount on Amazon purchases, or early access to products, services, or information offered by Amazon. The user and Amazon may also agree that the terms include monthly payments for updated information that Amazon may receive. This monthly payment may increase or decrease according to the quality or rating of the information Amazon receives. These transaction parameters or terms may be based on suggested optimal or relevant values provided by the system. It is important to note that a buyer or partner may provide a bid to buy user information even though an offer doesn't exist; Amazon may offer to purchase clothing buyer behavior information, even if the user doesn't have an active offer to sell the information. There are an extremely large number of methods or terms under which a user and partner may sell and buy information. Transacted information may come with a license to use, share, access, or store the information. It is also important to note that a user's information security and gatekeeping attributes may interact with offers and bids. For example, if a user's security or gatekeeping are set to not share or transact purchasing behavior for undergarments, the user's clothing information offers may not include any purchasing behavior for undergarments. Continuing with this example, Amazon may purchase all clothing purchase behavior and information, where undergarment purchasing behavior or information is not included. This may give Amazon the right to access, store, and use the information; and on expiration, such informational rights may be revoked. It is important to note that information offers or bids may include many partners or users; and information offers or bids may include many intermediaries or levels of intermediaries in the transaction. Continuing with this example, a user may designate a third party, such as Nike to sell or transact the user's clothing purchase information with Amazon; and this may include only clothing purchase information from Nike or may also include information including other organizations. It is important to note that privacy or privileged information parameters may limit some of the information offered or purchased, according to the parameters of a transaction. It is also important to note that information transactions may occur using VR, augmented reality, a life state, or a life view. In this example, the user may offer information for sale, or Amazon may purchase or bid for the information, while the user is using a virtual reality headset, where the user may be active with other activities, such as playing a game.

### Connected TV—Exemplary Usage

In an example of use as a function of Connected TV, a user or group of users may utilize connected TV for entertainment purposes. Connected TV utilizes streaming to deliver content to users while allowing personalized commercials or messages to be delivered to individual users. Partners may offer customized viewing and information consumption experiences for users or subsets from a group of users. In this example, Roku, a manufacturer of streaming devices and content host, may offer its devices or services to users, who may receive customized content, information, programming, and other forms of customized services or products that may be based on the user's attributes or behavior. A user who may have content viewing attributes preferring science fiction or fantasy, may receive Roku content recommendations, such as for science fiction or fantasy-based content. The user's customer experience or interface may also be customized in a way that emphasizes other types of content or information for science fiction and/or fantasy entertainment genres. Roku may also offer a channel or collection of streaming or live content based on the user's attribute alignment with science fiction or fantasy. Roku may offer customized controls, voice controls, augmented or virtual reality, or other means of interacting with Roku's content or devices based on the user's behavior attributes for science fiction or fantasy-based content. It is important to note that the user's behavioral profile may include information or attribute values from other sources of behavioral data such as content consumption or video game interactions. For this example, the user's behavior attributes involving science fiction and fantasy-based content may include viewing, interactions, or behavioral information from other experiences involving organizations or partners such as Amazon, Apple, Google, Netflix, and so on. It is important to note that behavioral information for content viewing may include very granular layers of attributes and sub-attributes or may include very granular layers of indirect attributes and sub-attributes, such as psychological, education, content consumption, event attendance, or other indirectly related consumer information. It is also important to note that some forms of information may be limited due to an organization's privacy and confidentiality policies. In this example, Roku may also customize all its science fiction or fantasy-based products or services for a user that factors in user attribute or sub-attribute values. These include, but are not limited to, psychological predispositions for intense or frightening content, science fiction or fantasy-based sophistication, previously consumed science fiction or fantasy-based products, or attendance to science fiction or fantasy-based events. Additionally, deeper levels of science fiction attributes or sub-attributes may be used to determine more specific interests in science fiction or fantasy content, such as sub-genre or year of production. In this example, a user's interactions with Roku's content may be customized as science fiction/fantasy content, from the 2000s up to the current date, with an emphasis on alien or otherworldly themes, but not including science fiction/horror. In this example, Roku may also utilize targeted advertising for science fiction/fantasy content consumption. A Roku user may receive advertising that is specific to its behavior attribute values, such as new science fiction or fantasy movies, series, documentaries, etc., or new streaming content providers that may have large science fiction or fantasy libraries, or new technology or gaming products or services, or merchandise, or events that may relate to science fiction or fantasy. In this example, the Roku user may receive advertising or information for a new Lord of The Rings series, the Tubi streaming service, a PlayStation 5 bundled with a science fiction game, and/or the next Comic-Con conference. In this example, the targeted advertising may use deeper targeted customization from the attributes or sub-attributes by filtering out content or information prior to the year 2000, while emphasizing alien or otherworldly themes, while also filtering out specific science fiction/horror, such as the Alien franchise. It is important to note that by use of learning or artificial intelligence, the system may analyze the user's behavior, attributes, or sub-attributes, and may determine optimal behavioral attributes or sub-attributes, so that specific genre or sub-genre based depictions align with the user's current and future behavior; and the system may recommend changes to the attributes, sub-attributes, as well as how organizations such as Roku may use the information or present content, information, interactions, or targeted advertising. These changes may be automatically populated into the user's profile and modify the user's life state.

The inventor also wishes to clarify his meaning for certain terms in the specification and claims. Unless specifically stated otherwise, it is appreciated that throughout the description, terms such as “processing” or “computing” or “calculating” or “determining” or “displaying” or the like, refer to the action and processes of a computing system, or similar electronic computing device, that manipulates and transforms data represented as physical quantities (i.e., electrons or similar charges) within the computing system's registers and memories. The resultant transformed data may also be represented as physical quantities within the computing system memories or registers, or other such information storage, transmission, or display devices. Mirrored databases and mirrored servers may be used to secure duplicate copies of data and computer instructions in separate physical locations; the actual mirrored servers' components do not need to be identical. The use of mirrored databases and mirrored servers may enhance the speed at which the computing systems perform their functions. A partner server and partner database may be separate from the information delivery server and its associated databases; the partner server and partner database may be comprised of identical or totally different components and software. A credit score is a rating of the user's past behavior with respect to paying bills, earning salary, or having assets. The credit score is not a financial instrument or a financial transaction; it cannot be used to purchase anything. The credit score history is a list of current and prior credit scores.

An electronic apparatus for facilitating the sale of a product or service comprises non-volatile memory, one or more processors, and bi-directional communications circuits linked to a network, the network in further communication through a firewall with a partner computing system and one or more data repositories, wherein the data repositories store data relevant to a user, the data relevant to a user comprising one or more data strings corresponding to at least one of demographic, ethnic, social, or psychological information, the data strings further relaying an indication of interaction with the user, wherein the indication of interaction is transmitted through the network to the data repositories and the partner computing system, the partner computing system comprising displays with representations that the indication of interaction has occurred.

The electronic apparatus above wherein the indication of interaction comprises the sale of a product or service.

The electronic apparatus above wherein the data relevant to a user comprises information that the user attended an event.

The electronic apparatus above wherein the data relevant to a user comprises information that the user has a psychological need.

The electronic apparatus above wherein the one or more strings of data are weighted for alternative versions of the indication of interaction.

A method of electronically associating an online identity with each of a multitude of users comprises accessing a networked apparatus comprising non-volatile memory, one or more processors, and bi-directional communications circuits through a firewall, the networked apparatus in communication with similar networked devices, determining a set of user attributes for each of the multitude of users and accessing one or more of the similar networked devices, the accessing further creating traffic between the networked devices, the traffic comprising data strings representing attributes of the users, wherein the data strings correspond to at least one of medical, health, communication, security, career, location, demographic, ethnic, social, or psychological information about the users.

The method above wherein the data strings are determined by accessing the multitude of users' email messages.

The method above wherein the data strings are determined by accessing the multitude of users' text messages, received notifications, or live data feeds.

A system comprises information delivery servers connected to a network through a firewall, the information delivery servers configured to communicate with an email server, the email server providing service to a user, the user sending and receiving email messages containing at least one of demographic, ethnic, social, or psychological information relevant to the user, wherein the information delivery servers access, read, or view the contents of the email messages.

The system above wherein the email messages contain attachments in the form of documents or photographs.

The system above wherein the contents of the email messages provide an indication that a relevant product or service is required.

The system above wherein the information about the user's life is stored in a Personal Storage Table (.pst) file format or an Offline Storage Table (.ost) file format.

The system above wherein the information about the user's life is stored in one or more of the following: flat files, spreadsheet files, cloud storage, key value stores, in-memory storage, document stores, object stores, metadata, message queues, log files, configuration files, cache, BLOBs (Binary Large Objects), compressed archive files, file systems, spatio-temporal data structures (geographic information systems), views, index files, stored procedures, functions, triggers, sequences, schemas, constraints, or synonyms.

An electronic apparatus for training a first information delivery system to respond to new activity comprises a first allocation of non-volatile memory, a first set of one or more processors, one or more first data repositories, and first bi-directional communications circuits linked to a network through a first firewall, wherein the first data repositories store first datasets relevant to a first group of one or more users, the first datasets comprising one or more first data strings with values relevant to the activity of the first group of one or more users, the network in further communication with a second information delivery system comprising a second allocation of non-volatile memory, a second set of one or more processors, one or more second data repositories, and second bi-directional communications circuits linked to the network through a second firewall, wherein the second data repositories store datasets relevant to a second group of one or more users, the second datasets comprising one or more second data strings with values relevant to the activity of the second group of one or more users, the first information delivery server requesting select data strings from the second information delivery server, the second information delivery server sending the select data strings to the first information delivery server in accordance with limitations determined by the second group of one or more users, the first information delivery server identifying any difference between the received select data string values and the first data string values, and the first information delivery server automatically changing the first data string values to match the select data string values if they exceed a preset threshold, the changed first data string values enhancing the representation of the user's response to the new activity.

The electronic training apparatus above further comprising the automatic creation of new categories in the first dataset if the second data strings or select data strings do not correspond to pre-existing categories in the first dataset.

The electronic training apparatus above further comprising a first dataset populated with null values and the first information delivery server automatically populating all or part of the first dataset with values from the second dataset.

The electronic training apparatus above further comprising a second information delivery server receiving data values indicative of new activity by a user, the second information delivery server automatically sending the data values to a first information delivery server, the first information delivery server in receipt of the data values and automatically populating one or more datasets with the data values.

The electronic training apparatus above further comprising the storage of values indicative of user activity when one or more users visit a website controlled or monitored by a partner registered on first or second information delivery servers.

The electronic training apparatus above further comprising one or more data values received from one or more sensors indicative of activity by one or more users.

The electronic training apparatus above, with respect to the sensor data values, further comprising the storage of one or more data values from one or more sensors indicative of activity from one or more users.

The electronic training apparatus above, with respect to the sensor data values, further comprising sensor data values indicative of at least one of location, position, orientation, GPS coordinates, temperature, pressure, weight, environmental light, or radio-frequency signal.

The electronic training apparatus above, with respect to the sensor data values, further comprising sensor data values that are continuously or intermittently transmitted to one or more information delivery servers.

An apparatus that transforms data from an old non-volatile memory state to a new non-volatile memory state comprises an information delivery server that connects through a network to communicate with one or more sensor devices, the information delivery server comprising at least one data processor device, network communication devices, and memory storage devices, the sensor devices generating sensor output values for at least one of location, position, orientation, GPS coordinates, temperature, pressure, weight, light, Bluetooth signal, or other electromagnetic signal, the sensor output values transmitted through the network to the information delivery server, held in the memory storage devices, and read by the data processor devices, the data processor devices changing the old non-volatile memory state to store the sensor output values as the new non-volatile memory state.

The apparatus above further comprising a first set of data values that emulate the sensor output values and one or more additional sets of data that emulate old memory states, the first set of data values applied to train the information delivery server, the information delivery server determining changes to values in the old memory states.

An electronic apparatus for storing values corresponding to a user's behavior comprises non-volatile memory, one or more processors, one or more displays, and bi-directional communications circuits linked to a network through a firewall, the network in further communication with one or more sensors, one or more data repositories, and the displays, wherein the data repositories store data relevant to the user, the data relevant to the user comprising one or more values corresponding to sensors capable of detecting at least one of location, position, orientation, GPS coordinates, temperature, pressure, weight, light, Bluetooth signal, or other electromagnetic signal, the displays showing images corresponding to the sensor data values.

The electronic apparatus above wherein the network is comprised of one or more of the Internet, a cell phone network, a local area network (LAN), or a wide area network (WAN).

The electronic apparatus above wherein the user is tracked over a period of time.

The electronic apparatus above wherein the user is tracked in a specific geographic location.

A method for improving the probability of a sale to a user comprises reading multiple streams of data through a firewall, the multiple streams of data comprising user contact information, product data, pricing data, email message contents, and data relevant to the user, identifying the needs of the user, and extending an offer of a product or service to the user.

The method above wherein the step of identifying one or more needs of the user comprises reading the email messages.

The method above wherein the step of identifying one or more needs of the user comprises at least one of demographic, ethnic, social, or psychological information relevant to the user.

A method of rating a partner of an information delivery system wherein such rating is used to determine the level of access the partner has to user information based on alignment of the partner's products and services with the needs of the user.

A method of rating a user of an information delivery system wherein such rating is used to determine the level of access a partner has to the user information based on alignment of the partner's products and services with the needs of the user.

A method of assigning an online identification to each of a multitude of users based on at least one of demographic, ethnic, social, or psychological information relevant to the user.

The method above wherein the online identification allows for the clustering of users into groups with common traits.

The method above, with respect to groups of users with common traits, wherein the contact information for the groups of users is sold, auctioned, bartered, or traded to a third party.

The method above, with respect to the sale, auction, barter, or trade of contact information, wherein the contact information for the groups of users is subject to a privacy policy that controls whether or not the contact information may be sold, auctioned, bartered, or traded to a third party.

An electronic apparatus for simulating a virtual reality environment comprises non-volatile memory, one or more processors, one or more headset displays, and bi-directional communications circuits linked to a network, the network in further communication with a partner computing system and one or more sensors, data repositories, and the headset displays, wherein the data repositories store data relevant to a user, the data relevant to a user comprising one or more data strings corresponding to at least one of demographic, ethnic, social, or psychological information, the headset displays worn by the user to view images transmitted through the network, the images comprising depictions of one or more actuators, the actuator depictions in communication with the sensors through the network, the sensors relaying an indication of interaction with the user, wherein the indication of interaction is transmitted through the network to the data repositories and the partner computing system, the partner computing system comprising displays with representations that the indication of interaction has occurred.

The electronic apparatus above wherein the partner computing system transmits a message to the user in response to the indication of interaction.

The electronic apparatus above, with respect to the response message, wherein the response message comprises information that is relevant to the user.

The electronic apparatus above, with respect to the response message, wherein the response message comprises at least one of a request for access to the user's data repository or a rating of the user's indication of interaction.

The electronic apparatus above wherein the user's indication of interaction comprises at least one value for parameters that control access to the data repository, grant permission for the partner to access portions of the user's data, deny access to the user's data, change or delete portions of the user's data, or limit or restrict the communication between the partner and the user.

The electronic apparatus above comprising a sensor output that indicates values for at least one of location, position, orientation, GPS coordinates, temperature, pressure, weight, light, Bluetooth signal, or other electromagnetic signal.

An information delivery server for storing and modifying data records of a user comprises non-volatile memory, one or more processors, and bi-directional communications circuits, the bi-directional communications circuits linked to a network through a first firewall in which a user computing system is linked to the network through a second firewall, the information delivery server enabling security and gatekeeping features to preserve the data record integrity, the security features allowing only authorized users to access the data records on the information delivery server, the gatekeeping features allowing the authorized users access to authorized portions of the user data records.

The information delivery server above further comprising one or more headset displays wherein the server simulates a virtual reality environment.

The information delivery server above wherein the user rates the accuracy of the data entered by third parties.

The information delivery server above wherein a partner of the information delivery server rates the accuracy of the data entered by the user.

A method for increasing the frequency of a sale of products or services to a user comprises reading multiple streams of data passing through a firewall connected to a network, the multiple streams of data comprising user email message contents and data relevant to the user, and sending an advertisement to the user that is responsive to user needs detected in the multiple streams of data.

The method above wherein the email message contents are stored in a Personal Storage Table (.pst) file format.

The method above wherein the email message contents are stored in an Offline Storage Table (.ost) file format.

The method above wherein the email message contents comprise photos and documents.

The method above wherein the email message contents comprise data strings corresponding to at least one of demographic, ethnic, social, or psychological information of the user.

The method above, with respect to the data strings, wherein the data strings are read and then used to trigger a targeted communication to the user.

The method above, with respect to the targeted communication, wherein the targeted communication is an advertisement for a product or service.

An apparatus for enhancing the stored data of a registered user of an information delivery system comprises the information delivery system comprised of non-volatile memory, one or more processors, and bi-directional communications circuits connected to a network through a firewall, an email server connected to the network through a firewall, the email server containing email files with information relevant to the user, a program on the information delivery system for reading the email files and extracting the information relevant to the user, bundling the information relevant to the user into new files with categories and sub-categories associated with the identity of the user, and transferring the new files to one or more third parties through the network.

The apparatus above wherein the email files comprise information relevant to the user in the form of one or more data strings corresponding to at least one of demographic, ethnic, social, or psychological information.

The apparatus above wherein the email files comprise Personal Storage Table (.pst) file formats.

The apparatus above wherein the email files comprise Offline Storage Table (.ost) file formats.

The apparatus above, with respect to the data strings, wherein the one or more data strings indicate a physical or psychological need of the user.

The apparatus above, with respect to the data strings, wherein the one or more data strings comprise text, documents, or photographs.

A method of rating a registered user of an information delivery system comprises determining categories and sub-categories that represent the life state of the registered user, the categories and sub-categories comprised of data strings relevant to attributes of the registered user, comparing the data strings with criteria from a registered partner of the information delivery system, and rating the registered user based on the probability that a transaction for goods or services will occur.

A method of rating a registered partner of an information delivery system comprises determining categories and sub-categories that represent the product and service offerings of the registered partner, the categories and sub-categories comprised of data strings relevant to attributes of the product and service offerings, comparing the data strings with criteria from a registered user of the information delivery system, and rating the registered partner based on the probability that a transaction for goods or services will occur.

An apparatus for viewing a three-dimensional representation of a user's life comprises a headset worn by the user, non-volatile memory, one or more processors, one or more displays, and bi-directional communications circuits linked to a network through a firewall, the network in further communication with one or more sensors for detecting the user's motion or actions in the real world, the displays projecting images to the user, the images comprising actuators for the user to make a selection in the virtual world and further comprising representations of products or services for the user to select, the selected products or services reported back to an information delivery server through the network.

An electronic apparatus for facilitating the transfer of a user's information to a partner of an information delivery system comprises non-volatile memory, one or more processors, and bi-directional communications circuits linked to a network through a firewall, the network in further communication with the information delivery system and one or more data repositories, wherein the data repositories store data relevant to the user, the data relevant to the user comprising one or more data strings corresponding to at least one of demographic, ethnic, social, or psychological information, the data strings further comprising an indication that the user's information has transferred to the partner.

The electronic apparatus above wherein the data string further comprises the transaction for a user's information.

The electronic apparatus above, with respect to the transaction data string, wherein the data string relevant to the transaction for the user information is exchanged between two or more partners.

The electronic apparatus above wherein the user information transaction is initiated by the user according to transaction parameters selected by the user.

The electronic apparatus above wherein the user information transaction is initiated by the partner according to transaction parameters selected by the user.

The electronic apparatus above wherein the user information transaction comprises data strings indicating current user behavior and future user behavior.

The electronic apparatus above wherein the user information transaction comprises one or more partners accessing the user information.

The electronic apparatus above wherein the user information transaction results in one or more partners accessing the user's future information.

The electronic apparatus above wherein the data strings from multiple user transactions are stored in a repository of user transaction data.

An electronic apparatus for facilitating the transfer of a user's information to a partner comprises non-volatile memory, one or more processors, and bi-directional communications circuits linked to a network through a firewall, the apparatus transferring a data string of user information to the partner through the firewall, the data string comprising transactions for the user's information.

The electronic apparatus above wherein the partner acquires a user's information.

The electronic apparatus above wherein the transfer of a user's information to a partner is executed between one or more users and one or more partners.

The electronic apparatus above wherein the transfer of a user's information is initiated by the partner.

The electronic apparatus above wherein the partner offers terms for a transaction.

The electronic apparatus above, with respect to the terms for a transaction, wherein the terms for a transaction comprise a sale, an auction, or a trade for goods or services.

The electronic apparatus above wherein the data string comprising the user's information comprises current behavior and future behavior.

The electronic apparatus above wherein the user's information is updated upon receipt of new information.

The electronic apparatus above wherein user transactions are stored in a repository of user transaction data.

What is claimed is:

1. An electronic apparatus for facilitating a sale of a product or service, said apparatus comprising:
non-volatile memory, one or more processors, and bi-directional communications circuits linked to a network,
said network in further communication through a firewall with a partner computing system and one or more data repositories, wherein said one or more data repositories store data relevant to a user,
said data relevant to the user comprising one or more data strings corresponding to at least one of demographic, ethnic, social, or psychological information;
said one or more data strings further relaying an indication of interaction with said user, wherein said indication of interaction is transmitted through said network to said one or more data repositories and said partner computing system; and
said partner computing system comprising displays with representations that said indication of interaction has occurred.

2. The electronic apparatus of claim 1, wherein the indication of interaction comprises the sale of the product or service.

3. The electronic apparatus of claim 1, wherein said data relevant to the user comprises information that said user attended an event.

4. The electronic apparatus of claim 1, wherein said data relevant to the user comprises information that said user has a psychological need.

5. The electronic apparatus of claim 1, wherein said one or more data strings are weighted for alternative versions of said indication of interaction.

6. A system, comprising:
information delivery servers connected to a network through a firewall, the information delivery servers configured to:
communicate with an email server, said email server providing service to a user, said user sending and receiving email messages containing at least one of demographic, ethnic, social, or psychological information relevant to said user,
wherein said information delivery servers access, read, or view a contents of said email messages.

7. The system of claim 6, wherein said email messages contain attachments in a form of documents or photographs.

8. The system of claim 6, wherein the contents of said email messages provide an indication that a relevant product or service is required.

9. The system of claim 6, wherein the information about the user's life is stored in a Personal Storage Table file format or an Offline Storage Table file format.

10. The system of claim 6, wherein the information about the user's life is stored in one or more of the following: flat files, spreadsheet files, cloud storage, key value stores, in-memory storage, document stores, object stores, metadata, message queues, log files, configuration files, cache, BLOBs (Binary Large Objects), compressed archive files, file systems, spatio-temporal data structures (geographic information systems), views, index files, stored procedures, functions, triggers, sequences, schemas, constraints, or synonyms.

11. An electronic apparatus for storing values corresponding to a user's behavior comprising:
non-volatile memory, one or more processors, one or more displays, and bi-directional communications circuits linked to a network through a firewall,
said network in further communication with one or more sensors, one or more data repositories, and said displays, wherein said one or more data repositories store data relevant to said user,
said data relevant to said user comprising one or more values corresponding to sensors capable of detecting at least one of location, position, orientation, GPS coordinates, temperature, pressure, weight, light, blue tooth signal, or other electromagnetic signal, and
said displays showing images corresponding to said one or more values.

12. The electronic apparatus of claim 11, wherein the network is comprised of one or more of the Internet, a cell phone network, a local area network (LAN) or a wide area network (WAN).

13. The electronic apparatus of claim 11, wherein the user is tracked over a period of time.

14. The electronic apparatus of claim 11, wherein the user is tracked in a specific geographic location.

15. A method for increasing a frequency of a sale of products or services to a user, comprising:
reading multiple streams of data passing through a firewall connected to a network, said multiple streams of data comprising user email message contents and data relevant to said user, and
sending an advertisement to said user that is responsive to user needs detected in said multiple streams of data.

16. The method of claim 15, wherein the user email message contents are stored in a Personal Storage Table (.pst) file format.

17. The method of claim 15, wherein the user email message contents are stored in an Offline Storage Table (.ost) file format.

18. The method of claim 15, wherein the user email message contents comprise photos and documents.

19. The method of claim 15, wherein data strings are read and then used to trigger a targeted communication to the user.

20. The method of claim 19, wherein the targeted communication is the advertisement for a product or service.
